(19) United States
(12) Patent Application Publication
(10) Pub. No.: US 2007/0202427 A1
(43) Pub. Date: Aug. 30, 2007

(54) TONER, METHOD FOR PREPARING THE TONER, DEVELOPER INCLUDING THE TONER, AND IMAGE FORMING METHOD AND APPARATUS AND PROCESS CARTRIDGE USING THE TONER

(76) Inventor: Chiaki TANAKA, Izunokuni-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/676,883

(22) Filed: Feb. 20, 2007

(30) Foreign Application Priority Data
Feb. 27, 2006 (JP) 2006-050426

(51) Int. Cl. G03G 9/093

(52) U.S. Cl. 430/110.2; 430/137.11; 430/123.5

(57) ABSTRACT

A method for preparing a toner including providing toner particles including at least a binder resin; and contacting a coating fluid including a silicone resin and at least one of a super critical fluid and a sub-critical fluid with a surface of the toner particles to form thereon a layer including the silicone resin. A toner prepared by the method. A developer including the toner and an optional carrier. An image forming method, and image forming apparatus, and a process cartridge using the developer.

### BACKGROUND OF THE INVENTION

1. Field of the Invention

The present invention relates to a toner for use in a developer developing an electrostatic image. In addition, the present invention also relates to a developer including the toner, and an image forming method, an image forming apparatus and a process cartridge using the toner.

2. Discussion of the Background

In electrophotographic image forming apparatuses and electrostatic recording apparatuses, an image is formed as follows:
(1) an electrostatic latent image (or a magnetic latent image) formed on an image bearing member (such as photoreceptors) is developed with a developer including a toner to form a toner image thereon (developing process);
(2) the toner image is transferred onto a receiving material (transfer process); and
(3) the toner image on the receiving material is heated and pressed to be fixed thereon, resulting in formation of an image (fixing process).

When a full color image is formed, black, yellow, magenta and cyan color toners are typically used for developing electrostatic images corresponding to a black image, a yellow image, a magenta image and a cyan image, which constitute the full color image. In this regard, the resultant four color toner images are overlaid on a receiving material, and the overlaid toner images are fixed at the same time upon application of heat and pressure thereto.

However, the image quality of full color images produced by such full color image forming apparatuses is not satisfactory when the full color images are compared with print images, and particularly a need exists for electrophotographic full color images having the same resolution as photograph and print images. In order to produce high quality images by electro photography, it is effective to use a toner having a small particle diameter and a narrow particle diameter distribution.

Toner for use in developing an electrostatic (or magnetic) image is typically a particulate colored material having a configuration such that a colorant, a charge controlling agent and other additives are included in a binder resin. Methods for preparing such a particulate colored material are broadly classified into pulverization methods and polymerization methods.

The pulverization methods typically include the following processes:
(1) toner constituents such as a colorant, a charge controlling agent and an offset preventing agent are kneaded together with a binder resin upon application of heat thereto to prepare a kneaded toner constituent mixture (kneading process);
(2) after being cooled, the kneaded mixture is pulverized; and
(3) the pulverized mixture is classified to prepare a particulate colored material (i.e., toner particles).

The pulverization methods have an advantage in that the resultant toner has a combination of medium-level properties, but have a drawback in that raw materials used for preparing the toner are limited. For example, the mixture prepared by melting and kneading toner constituents has to be pulverized and classified with conventional pulverizers and classifiers. Specifically, the kneaded mixture has to be brittle enough to be pulverized by conventional pulverizers. Therefore, when a kneaded mixture is pulverized, the resultant powder tends to have a broad particle diameter distribution. In order to produce images with a good combination of resolution and half tone properties, the particle diameter of toner particles is preferably from 5 μm to 20 μm. Therefore, fine particles having a particle diameter of less than 5 μm, and coarse particles having a particle diameter of greater than 20 μm have to be removed from the resultant powder, resulting in serious decrease in yield of the toner in the classification process. In addition, it is difficult for the pulverization methods to uniformly disperse a colorant and a charge controlling agent in a thermoplastic resin (i.e., a binder resin). Uneven dispersion of such toner constituents adversely affects the fluidity, developability, durability and image qualities of the resultant toner.

Published unexamined Japanese Patent application No. (hereinafter referred to as JP-A) 09-043909 discloses a suspension polymerization method of preparing a toner. The toner prepared thereby has a spherical shape and has poor cleanability. There is a small amount of residual toner on an image bearing member after an image having a low image area is developed or transferred, and therefore the poor cleanability does not cause a serious problem. However, there is a case where a large amount of toner particles remain on an image bearing member without being transferred when an image having a high image area proportion such as photograph images is developed and transferred or a receiving material is not fed to the transfer position due to misfeed. In this case, the residual toner particles cause a background development problem in that background are as of a toner image are soiled with toner particles. In addition, such residual toner particles contaminate a charging roller charging the image bearing member, thereby impairing the original chargeability of the charging roller. Further, the toner prepared by the suspension polymerization method does not have good low-temperature fixability and in addition much energy is consumed to fix the toner.

Japanese Patent No. 2537503 and JP-A 2000-292973 have disclosed methods of preparing toner particles having irregular forms by aggregating a particulate resin prepared by an emulsion polymerization method. However, a large amount of surfactant remains not only on the toner particles but also in the toner particles, thereby impairing the charge stability of the toner to withstand environmental conditions and widening the charge quantity distribution thereof, resulting in occurrence of the background development problem. In addition, the surfactant remaining on or in the toner particles contaminate image bearing members, charging rollers and developing rollers, resulting in deterioration of the chargeability of the members.

In a contact heat fixing process using a heating member such as a heat roller, the toner is required to have good releasability from the heating member (this releasability is hereinafter referred to as offset resistance). The offset resistance of a toner can be improved by locating a release agent on the surface of the toner particles. JP-A 2000-292978 and Japanese patent No. 3141783 have disclosed methods of improving the offset resistance of toner by not only including a particulate resin in the toner particles but also unevenly distributing the particulate resin on the surface thereof. However, the lowest fixable temperature of the toner increases, namely the toner has insufficient low-temperature fixability.

Further, the methods of preparing toner particles having irregular forms by associating a particulate resin prepared by an emulsion polymerization method have the following problems. Specifically, when a particulate release agent is associated with toner particles to improve the offset resistance thereof, the particulate release agent is incorporated therein, resulting in insufficient improvement of the offset resistance. In addition, a particulate rein, a particulate release agent and a particulate colorant are randomly fusion-bonded with each other to form toner particles, and composition (component content ratios) of the toner particles and molecular weights of the resin therein vary. Therefore, a problem such that surface properties of the toner particles vary and high quality images cannot be produced over a long period of time occurs. Further, the particulate resin unevenly distributed on the surface of a toner impairs the low-temperature fixability of the toner (i.e., the toner has a narrow fixable temperature range).

A solution suspension method in which toner particles are prepared by a polymer dissolved in an organic solvent is known as a method of preparing a toner. The method has advantages such that various resins can be used therefor; polarity of the resultant toner particles can be easily controlled; and the structure (e.g., the core-shell structure) of the resultant toner particles can be easily controlled. However, the shell is constituted of a resin, (i.e., the shell is formed to prevent a pigment or a wax from being located on the surface of the toner particles), namely it is not intended to control the surface condition of the toner particles, as described in “Features of toners prepared by new methods and the future of the toners” disclosed by Ishiyama et al. in fourth Joint Symposium of Image Society Japan and The Institute of Electrostatics Japan. Namely, the toner has a core-shell structure but the surface of the toner is made of a general resin layer. Therefore, the toner has insufficient high temperature preservability and charge stability to withstand environmental conditions.

In addition, styrene—acrylic resins are typically used for suspension polymerization methods, emulsion polymerization methods, and solution suspension methods. When polyester resins, which have good low temperature fixability, are granulated, it is impossible to control the particle diameter, particle diameter distribution and shape of the resultant toner particles. Therefore, the resultant toner has insufficient low temperature fixability.

JP-A 11-133667 discloses a technique of using, as a binder resin, a urea-modified polyester resin for the purpose of improving high temperature preservability and low-temperature fixability. However, the resultant toner does not have sufficient charge stability to withstand environmental conditions.

In an electrophotographic field, to produce higher quality images has been studied from various angles, and particularly it is recognized that a spherical toner having a smaller diameter is highly effective for producing high quality images. However, the smaller the diameter of the toner, the lower the transferability and fixability of the toner, resulting in production of images having poor quality. JP-A 09-258474 discloses a method of forming a spherical toner to improve transferability. In the fields of color copiers and color printers, it is required to produce images at a higher speed. In order to produce images at a higher speed, it is effective to use a tandem type image forming apparatus as disclosed in JP-A 05-341617.

The tandem method is a method of producing a full-color image on a receiving material by sequentially overlying thereon toner images produced by plural image forming units. The tandem-type full-color image forming apparatuses can use a variety of receiving papers and produce high-quality full-color images at a higher speed than the other types of full-color image forming apparatuses.

An attempt to use a spherical toner for high speed image forming apparatuses is made. For example, spherical toners such as chemical toners form a toner image in which a dense toner particle layer is formed on an image bearing member, and thereby pressure is uniformly applied to the toner particle layer. Therefore, the toners hardly cause problems such that the transfer rate of toner images deteriorates and defective images such as hollow image sun like the pulverization toners. However, when such spherical toners are used for a long period of time, the transferability and fluidity thereof deteriorate at a relatively high speed compared to pulverization toners because the external additives on the spherical toners are embedded into the surface of the toner particles at a relatively high speed. Particularly, when images having small image area proportion are continuously produced, the external additives of the toners are embedded into the surface of the toner particles, resulting in deterioration of the fluidity of the toners. Therefore, a problem such as formation of uneven images caused by variation of transferability of the toners occurs. In addition, such small spherical toners tend to include a large amount of fluidity improving agent to impart good fluidity to the small toner particles. In this regard, the adhesiveness of the external additives to the toner particles deteriorates, resulting in increase of the amount of free external additives in the toners. Since such free external additives are easily transferred to image forming members such as photoreceptors, developing rollers and chargers, and a film is formed thereon, a problem in that image qualities deteriorate occurs.

Because of these reasons, a need exists for a toner having a good combination of transferability, cleanability, filming resistance and charge stability.

### SUMMARY OF THE INVENTION

As an aspect of the present invention, a method for preparing a toner is provided which includes the steps of providing toner particles including at least a binder resin; and contacting a coating fluid including a silicone resin and at least one of a super critical fluid and a sub-critical fluid with a surface of the toner particles to form thereon a layer including the silicone resin.

As another aspect of the present invention, a toner is provided which is prepared by the method mentioned above.

As yet another aspect of the present invention, a developer is provided which includes a carrier and the toner mentioned above. The toner mentioned above can be used as a one component developer.

As a further aspect of the present invention, an image forming method is provided which includes the steps of developing an electrostatic image on an image bearing member with a developer including the toner mentioned above to prepare a toner image on the image bearing member; transferring the toner image onto a receiving material; and fixing the toner image on the receiving material upon application of heat and pressure thereto.

As a still further aspect of the present invention, an image forming apparatus is provided which includes at least an image bearing member bearing an electrostatic image; a developing device developing the electrostatic image with a developer including the toner mentioned above to form a toner image on the image bearing member; a transfer device transferring the toner image onto a receiving material; and a fixing device fixing the toner image on the receiving material upon application of heat and pressure thereto.

As a still further aspect of the present invention, a process cartridge is provided which includes at least an image bearing member bearing an electrostatic image; and a developing device developing the electrostatic image with a developer including the toner mentioned above to form a toner image on the image bearing member, wherein the process cartridge is attachable to and detachable from an image forming apparatus.

These and other objects, features and advantages of the present invention will become apparent upon consideration of the following description of the preferred embodiments of the present invention taken in conjunction with the accompanying

### BRIEF DESCRIPTION OF THE DRAWINGS

FIG. 1 is a schematic view illustrating an example of the process cartridge of the present invention;

FIG. 2 is a schematic view illustrating an example of the image forming apparatus of the present invention;

FIG. 3 is a schematic view illustrating another example of the image forming apparatus of the present invention;

FIG. 4 is a schematic view illustrating yet another example of the image forming apparatus of the present invention;

FIG. 5 is a schematic view illustrating an image forming section of the image forming apparatus illustrated in FIG. 4; and

FIGS. 6-9 are schematic views illustrating apparatuses for use in preparing the toners of Examples 1 to 4, respectively.

### DETAILED DESCRIPTION OF THE INVENTION

The method of the present invention for preparing a toner includes the steps of providing toner particles including at least a binder resin; and contacting a coating fluid including a silicone resin and at least one of a super critical fluid and a sub-critical fluid with a surface of the toner particles to form thereon a layer including the silicone resin (this layer is hereinafter referred to as a covering layer). The method for forming a covering layer on toner particles is not particularly limited so long as a fluid in which a silicone resin is dissolved in a super critical fluid or sub-critical fluid is used.

Specific examples of the method for forming a covering layer on toner particles are as follows:
(1) A fluid in which a silicone resin is dissolved in a super critical fluid and/or a sub-critical fluid is coated on the surface of the toner particles by a spray coating method.
(2) A fluid in which a silicone resin is dissolved in a super critical fluid and/or a sub-critical fluid is mixed with the toner particles under pressure, and then the pressure applied to the mixture is rapidly reduced to expand the fluid. In this case, the silicone resin is precipitated on the peripheral surface of the toner particles.
(3) A fluid in which a silicone resin is dissolved in a super critical fluid and/or a sub-critical fluid is mixed with the toner particles under pressure, and then at least one of the pressure and the temperature is changed to decrease the solubility of the silicone resin to the super critical fluid and/or sub-critical fluid. In this case, the silicone resin is precipitated on the peripheral surface of the toner particles.

The apparatus for use in forming a covering layer on toner particles is not particularly limited. For example, apparatuses having a pressure-resistant container for preparing a fluid in which a silicone resin is dissolved in a super critical fluid and/or a sub-critical fluid, and a pressure pump for feeding the super critical fluid and/or sub-critical fluid to the container can be used. Specifically, at first a silicone resin is fed into the pressure-resistant container, and then a super critical fluid and/or a sub-critical fluid are fed into the container using the pressure pump to prepare a coating fluid. The thus prepared coating fluid is contacted with toner particles to form a covering layer on the surface of the toner particles. In this regard, carbon dioxide is preferably used as the super critical fluid or sub-critical fluid because the fluid becomes a gas when the atmospheric conditions are changed to normal temperature and normal pressure (i.e., 25° C. and one atm.) and therefore it is unnecessary to perform a troublesome solvent removing operation. In addition, it is unnecessary to perform a washing treatment on the toner particles, resulting in avoidance of waste water and decrease of burdens on the environment.

The temperature at which a fluid including a silicone resin and a super critical fluid and/or a sub-critical fluid is mixed with toner particles is not particularly limited so long as the super critical fluid and/or sub-critical fluid are present at the temperature, but is preferably from 0 to 100° C. and more preferably from 20 to 80° C. When the temperature is too high, a problem in that the toner particles dissolve in the liquid occurs.

The pressure at which a liquid including a silicone resin and a super critical fluid and/or a sub-critical fluid is mixed with toner particles is not particularly limited as long as the super critical fluid and/or sub-critical fluid are present at the pressure, and is preferably from 1 to 60 MPa.

Super critical fluids have intermediate properties between gasses and liquids, and have the following properties:
(1) Mass transfer and heat transfer can be rapidly performed;
(2) The viscosity thereof is low;
(3) By changing temperature and/or pressure, the properties thereof such as density, dielectric constant, solubility parameter, and free volume can be widely changed;
(4) Since the surface tension thereof is much lower than those of organic solvents, various materials can be well wetted by the super critical fluid even when the materials have rough surface.

Super critical fluids are defined as materials which are present as a noncondensable high density fluid under temperature/pressure conditions higher than critical points thereof below which the materials can have both a gas state and a liquid state at the same time. Any known super critical fluids can be used for the present invention. Super critical fluids having a low critical temperature and a low critical pressure are preferably used for the present invention.

Sub-critical fluids are defined as materials which are present as a high pressure liquid under a temperature/pressure condition in the vicinity of the critical point of the materials. Any known sub-critical fluids can be used for the present invention.

Specific examples of the materials for use as the super critical fluid and sub-critical fluid in the present invention include carbon monoxide, carbon dioxide, ammonia, nitrogen, water, methanol, ethanol, ethane, propane, 2,3-dimethylbutane, benzene, chlorotrifluoromethane, dimethyl ether, etc. Among these materials, carbon dioxide is preferably used because of having a critical temperature (31° C.) near room temperature and a critical pressure (7.3 MPa) near normal pressure. Therefore, carbon dioxide can be easily changed to a super critical state. In addition, carbon dioxide is highly safe because of being nonflammable. Further, super critical carbon dioxide achieves a gas state under normal temperature and normal pressure conditions. Therefore, carbon dioxide can be easily collected and reused. Further more, it is not necessary to dry the toner particles treated by a fluid including super critical carbon dioxide, and a waste liquid is not generated. One or more of super critical fluids and sub-critical fluids can be used for the toner preparation method of the present invention.

The critical temperature and critical pressure are not particularly limited, but the critical temperature is preferably from −273 to 300° C. and more preferably from 0 to 200° C. The critical pressure is preferably as low as possible because the load to toner preparation devices, the costs of toner preparation devices, and the energy used for preparing the toner are low. The critical pressure is preferably from 1 to 100 MPa, and more preferably from 1 to 50 MPa.

The method of the present invention forms a covering layer on the surface of toner particles utilizing the advantages of super critical fluids and/or sub-critical fluids. Since super critical fluids and sub-critical fluids can be easily separated from the product (i.e., the treated toner particles) and collected, the fluids can be reused. Thus, the method of the present invention is an innovative method which is environmentally-friendly because of using no solvent such as water and organic solvents.

In the method of the present invention, another fluid can be added to the super critical fluid and/or sub-critical fluid in order to control the solubility of the materials constituting the toner particles to the super critical fluid and/or sub-critical fluid. Specific examples thereof include methane, ethane, propane, ethylene, etc.

In addition, an entrainer (i.e., an azeotropicagent) can be added to the super critical fluid and/or sub-critical fluid to control the solubility of the silicone resin to the fluid. Suitable materials for use as the entrainer include polar organic solvents. Specific examples of the polar organic solvents include methanol, ethanol, propanol, butanol, hexane, toluene, ethyl acetate, chloroform, dichloromethane, ammonia, melamine, urea, thioethylene glycol, etc.

The entrainer used for the present invention is preferably a poor solvent for the toner particles and the silicone resin to be used under normal temperature and normal pressure conditions. Namely it is preferable that the toner particles and the silicone resin are insoluble in the entrainer or are slightly swelled by the entrainer. Therefore, the entrainer preferably has a solubility parameter (SP value) different from the solubility parameter of the silicone resin used by 1.0 or more, and preferably 2.0 or more. Specific examples of the materials for use as the entrainer include methanol, ethanol and n-propanol, each of which has a relatively high solubility parameter, and n-hexane and n-heptane, each of which has a relatively low solubility parameter. When the solubility parameter difference is too large (for example, 5 or more), the wettability of the fluid including a silicone resin to the toner particles deteriorates, and in addition it becomes impossible to dissolve a silicone resin in a mixture of the entrainer and a super critical fluid and/or a sub-critical fluid.

The added amount of the entrainer is preferably from 0.1 to 10% by weight, and more preferably from 0.5 to 5% by weight, based on the total amount of the entrainer and the fluid. When the added amount is too small, the effect of the entrainer can be hardly produced. In contrast, when the added amount is too large, a problem in that the mixture cannot achieve a super critical state or a sub-critical state occurs.

The silicone resin for use in the covering layer of the toner particles is not particularly limited, and any known silicone resins can be used. In addition, any synthesized silicone resins and commercialized silicone resins can be used as the silicone resin. Specific examples of the commercialized strait silicone resins include KR271, KR255, KR152 (which are manufactured by Shin-Etsu Chemical Co., Ltd.), SR2400, SR2406, SR2410, 217, FLAKE RESIN 220, FLAKE RESIN 233, FLAKE RESIN 249, FLAKE RESIN Z-6018, and INTERMEDIATE (which are manufactured by Dow Corning Toray Silicone Co., Ltd.). Specific examples of the commercialized modified silicone resins include KR206 (alkyd-modified), KR5208 (acrylic-modified), ES1001N (epoxy-modified), KR305 (urethane-modified) (which are manufactured by Shin-Etsu Chemical Co., Ltd.), SR2115 (epoxy-modified), and SR2110 (alkyd-modified) (which are manufactured by Dow Corning Toray Silicone Co., Ltd.).

Among these silicone resins, silicone resins having the following structure are preferably used.

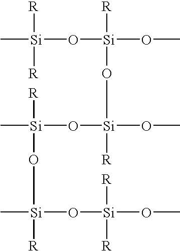

In the formula, R represents a hydrogen atom, a hydroxyl group, an alkoxyl group (e.g., a methoxyl group, and an ethoxyl group), an alkyl group (e.g., a methyl group, an ethyl group, and a propyl group) or an aryl group (e.g., a phenyl group, a tolyl group and a xylyl group).

Silicone resins can be used alone or in combination with another material such as crosslinkable components and charge controlling components.

The molecular weight of the silicone resin used for the covering layer is not particularly limited, but the weight average molecular weight thereof is preferably from 500 to 100,000 and more preferably from 1,000 to 10,000.

Silicone resins having a solid state under normal temperature and normal pressure conditions are preferably used for the silicone resin for use in the covering layer because of having a good combination of handling property, film forming property and thickness controlling property.

When the silicone resin is coated on the surface of the toner particles, it is preferable to crosslink the silicone resin. In order to crosslink the silicone resin, the silicone resin preferably has silanol groups in an amount of from 0.1 to 10% by weight, more preferably from 0.2 to 9% by weight and even more preferably from 0.3 to 8% by weight, based on the total weight of the silicone resin. When the amount of silanol groups is too large, problems such that the resultant crosslinked resin film becomes too hard and brittle, and unreacted silanol groups deteriorate charge stability of the resultant toner to withstand environmental conditions occur. When the silicone resin is crosslinked, any known catalysts for use in crosslinking silanol groups can be used. The amount of silanol groups is determined by the Karl-Fischer titration method described in JIS K0068 (The method for determining moisture in chemicals). The abstract of the method is as follows.
(1) The total amounts of SiOH and water (H₂O) in the sample are determined using a mixture solvent of methanol and chloroform;
(2) The amount of water (H₂O) in the sample is determined using a mixture solvent of pyridine and ethylene glycol; and
(3) The amount of SiOH is determined as the difference between the total amounts of SiOH and water (H₂O) and the amount of water.

Silanol groups remaining unreacted even after the crosslinking reaction are preferably treated with hexamethyl disilazane (HMDS) so that the covering layer has good hydrophobicity. In this case, the resultant toner has a good combination of fluidity and charging property even under high humidity conditions. Other hydrophobizing agents such as silane coupling agents, silylation agents, silane coupling agents having a fluorine-containing alkyl group, organic titanate coupling agents, aluminum coupling agents, silicone oils, modified silicone oils, etc. The added amount of such hydrophobizing agents is preferably from 1 to 40% by weight, and more preferably from 3 to 25% by weight, based on the weight of the silicone resin.

The thus hydrophobized toner preferably has a hydrophobicity of from 30 to 80%, which is determined by a wettability measuring method using methanol, i.e., a powder wettability tester WET-100P from RHESCA COMPANY LTD. Specifically, the procedure is as follows:
(1) 50 ml of pure water is fed into a 300 ml beaker;
(2) then 0.05 g of a sample (i.e., atoner) is fed into the beaker (in this case, the sample is floating on pure water);
(3) methanol is dropped thereto at a speed of 1 ml/min while agitating the mixture using a stirring bar; and
(4) the concentration (percentage) of methanol is defined as the hydrophobicity when the mixture has a transparency of 50%.

The covering layer can include a cleanability improving agent so that toner particles remaining on an image bearing member (such as photoreceptors and intermediate transfer media) can be easily removed therefrom. Specific examples of the cleanability improving agent include fatty acid metal salts (such as zinc stearate, and calcium stearate); particles of polymers such as polymethyl methacrylate, and polystyrene, which are prepared by a soap free emulsion polymerization method; etc. The polymer particles preferably have a narrow particle diameter distribution and a weight average particle diameter of from 0.01 to 1 μm. Further, the covering layer can include other materials such as fluidity improving agents, magnetic materials, and metal soaps.

The amount of the silicone resin in the covering layer can be determined by a fluorescent X-ray analyzer. Specifically, at first toner particles treated with a silicone resin in predetermined amounts (for example, 0.1%, 0.3%, 0.6%, 1.2 %, 2.4% and 4.8% based on the weight of the toner particles) are prepared. Then 3 g of each of the toners is pressed at a pressure of 6 t/cm², to prepare a disc-shaped pellet of the toner having a diameter of 40 mm. The thus prepared pellets are subjected to the fluorescent X-ray analysis using a wavelength dispersive fluorescent X-ray analyzer RIX3000 from Rigaku Corporation to prepare a working curve illustrating the relationship between the X-ray strength of the element (Si) and the amount of the silicone resin. Then a toner sample to be measured is also subjected to the fluorescent X-ray analysis to determine the amount of the silicone resin from the X-ray strength of the element (Si).

In the present invention, the toner particles includes at least a binder resin and a colorant, and optionally includes additives such as release agents and charge controlling agents.

The method for preparing the toner particles is not particularly limited, and pulverization methods and granulation methods (such as emulsion polymerization methods, suspension polymerization methods and polymer suspension polymerization methods), in which toner particles are prepared by performing emulsifying, suspending or coagulating using an oil phase and an aqueous phase, can be used. Among these methods, emulsion polymerization methods, suspension polymerization methods and polymer suspension polymerization methods are preferably used.

Specific examples of the resins for use as the binder resin of the toner particles include homopolymers of styrene or styrene derivatives, styrene copolymers, polymethyl methacrylate, polybutyl methacrylate, polyvinyl chloride, polyvinyl acetate, polyethylene, polyesters, polyurethane resins, epoxy resins, polyvinyl butyral resins, polyacrylic acid, rosin, modified rosins, terpene resins, phenolic resins, aliphatic or aromatic hydrocarbon resins, aromatic petroleum resins, etc. Specific examples of the polymers of styrene or styrene derivatives include polystyrene, poly-p-chlorostyrene and poly vinyl toluene. Specific examples of the styrene copolymers include styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers.

These resins can be used alone or in combination.

The toner particles for use in the present invention includes a colorant. Suitable materials for use as the colorant include known dyes and pigments.

Specific examples of the dyes and pigments include carbon black, Nigrosine dyes, black iron oxide, NAPHTHOL YELLOW S, HANSA YELLOW 10G, HANSA YELLOW 5G, HANSA YELLOW G, Cadmium Yellow, yellow iron oxide, loess, chrome yellow, Titan Yellow, polyazo yellow, Oil Yellow, HANSA YELLOW GR, HANSA YELLOW A, HANSA YELLOW RN, HANSA YELLOW R, PIGMENT YELLOW L, BENZIDINE YELLOW G, BENZIDINE YELLOW GR, PERMANENT YELLOW NCG, VULCAN FAST YELLOW 5G, VULCAN FAST YELLOW R, Tartrazine Lake, Quinoline Yellow LAKE, ANTHRAZANE YELLOW BGL, isoindolinone yellow, red iron oxide, red lead, orange lead, cadmium red, cadmiummercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED F2R, PERMANENT RED F4R, PERMANENT RED FRL, PERMANENT RED FRLL, PERMANENT RED F4RH, Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE RS, INDANTHRENE BLUE BC, Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials are used alone or in combination.

The content of the colorant in the toner is preferably from 1 to 15% by weight, and more preferably from 3 to 10% by weight of the toner.

Master batches, which are complexes of a colorant with a resin, can be used as the colorant of the toner for use in the present invention.

Specific examples of the resins for use as the binder resin of the master batches include polymers of styrene or styrene derivatives, copolymers of styrene with a vinyl monomer, polymethyl methacrylate, polybutyl methacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These can be used alone or in combination.

The toner particle for use in the present invention can include a release agent. Suitable materials for use as the release agent include waxes. Suitable waxes include carbonyl group containing waxes; polyolefin waxes; and long chain hydrocarbons. These waxes can be used alone or in combination. Among these waxes, the carbonyl group containing waxes are preferably used.

Specific examples of the carbonyl group containing waxes include esters of polyalkanoic acids (such as carnauba waxes, montan waxes, trimethylolpropane tribehenate, pentaerythritol tetrabehenate, pentaerythritol diacetatedibehenate, glycerin tribehenate, and 1,18-octadecanediol distearate); polyalcanol esters (suchas tristearyl trimellitate, and distearylmaleate); polyalkanoic acid amides (such as ethylenediamine dibehenyl amide); polyalkylamides (such as trimellitic acid tristearylamide); dialkyl ketones (such as distearyl ketone); etc.

Specific examples of the polyolefin waxes include polyethylene waxes and polypropylene waxes. Specific examples of the long chain hydrocarbons include paraffin waxes and SASOL WAX.

The release agent (wax) for use in the toner particles preferably has a melting point of from 40 to 160° C., more preferably from 50 to 120° C., and even more preferably from 60 to 90° C. When the melting point is too low, the resultant toner has poor high temperature preservability. In contrast, when the melting point is too high, the toner causes a cold offset problem in that a part of a toner image is adhered to a fixing roller at a relatively low fixing temperature, resulting in production of abnormal images.

The release agent (wax) included in the toner particles preferably has a melt viscosity of from 5 to 1,000 cps and more preferably from 10 to 100 cps when the melt viscosity is measured at a temperature 20° C. higher than that the melting point of the wax. When the melt viscosity is too high, good hot offset resistance and good low temperature fixability cannot be imparted to the toner.

The release agent (wax) is typically included in the toner particles in an amount of from 0 to 40 parts by weight, and preferably from 3 to 30 parts by weight, per 100 parts by weight of the toner. When the added amount of the release agent is too large, the fluidity of the toner deteriorates.

The toner particles can include a charge controlling agent to impart a positive or negative charge to the toner particles, wherein the polarity is determined depending on the polarity of charges to be formed on the surface of the image bearing member (e.g., photoreceptors).

Suitable materials for use as negative charge controlling agents include resins and compounds having an electron donating group, azo dyes, metal complexes of organic acids, etc.

Specific examples of the marketed negative charge controlling agents include BONTRON S-31, S-32, S-34, S-36, S-37, S-39, S-40, S-44, E-81, E-82, E-84, E-86, E-88, A, 1-A, 2-A, and 3-A (which are manufactured by Orient Chemical Industries Co., Ltd.); KAYACHARGE N-1 and N-2, and KAYASET BLACK T-2 and 004 (which are manufactured by Nippon Kayaku Co., Ltd.); AIZEN SPIRON BLACK T-37, T-77, T-95, TRH and TNS-2 (which are manufactured by Hodogaya Chemical Co., Ltd.); FCA-1001-N, FCA-1001-NB, and FCA-1001-NZ (which are manufactured by Fujikura Kasei Co., Ltd.); etc.

Suitable materials for use as positive charge controlling agents include basic compounds such as Nigrosine dyes, cationic compounds such as quaternary ammonium salts, metal salts of high fatty acids, etc. Specific examples of the marketed positive charge controlling agents include BONTRON N-01, N-02, N-03, N-04, N-05, N-07, N-09, N-10, N-11, N-13, P-51, P-52 and AFP-B (which are manufactured by Orient Chemical Industries Co., Ltd.); TP-302, TP-415, and TP-4040 (which are manufactured by Hodogaya Chemical Co., Ltd.); COPY BLUE PR, and COPY CHARGE PX-VP-435 and NX-VP-434 (which are manufactured by Hoechst A. G.); FCA 201, 201-B-1, 201-B-2, 201-B-3, 201-PB, 201-PZ, and 301 (which are manufactured by Fujikura Kasei Co., Ltd.); PLZ 1001, 2001, 6001 and 7001 (which are manufactured by Shikoku Chemicals Corp.); etc.

These charge controlling agents can be used alone or in combination.

The added amount of the charge controlling agent is determined depending on the properties of the binder resin used for the toner particles, and the method for preparing the toner particles. However, the added amount is generally from 0.1 to 10 parts by weight, and preferably from 0.2 to 5 parts by weight, based on 100 parts by weight of the binder resin included in the toner particles. When the added amount is too large, the toner has too large an amount of charge and thereby the electrostatic attraction between the toner and a developing roller excessively increases, resulting in occurrence of problems in that the fluidity of the toner deteriorates and the image density deceases. When the added amount is too small, the toner has poor charge rising property and a small amount of charge and therefore high quality images cannot be produced.

Next, the pulverization methods for preparing toner will be explained.

At first, a mixture of toner constituents such as a binder resin, a colorant and optional additives is kneaded by a kneader upon application of heat thereto. The kneading operation is performed using, for example, a kneader such as single or double axis continuous kneaders and batch kneaders. Specific examples of the kneaders include KTK double-axis extruders manufactured by Kobe Steel, Ltd., TEM double-axis extruders manufactured by Toshiba Machine Co., Ltd., double axis extruders manufactured by KCK Co., PCM double-axis extruders manufactured by Ikegai Corp., KO-KNEADER manufactured by Buss AG, etc.

It is preferable that the kneading operation is performed while controlling the kneading temperature so that the molecular chain of the binder resin used is not cut. Specifically, when the kneading temperature is higher than the softening point of the binder resin, the molecular chain of the binder resin tends to be cut. In contrast, when the kneading temperature is too low, the kneading operation cannot be well performed (i.e., the colorant cannot be well dispersed).

Then the kneaded mixture is pulverized. In this regard, it is preferable that the kneaded mixture is crushed at first, followed by pulverization. In the pulverization process, a method in which particles are collided to a plate using jet air; a method in which particles are collided to each other using jet air; and a method in which particles are pulverized at a narrow gap between a rotor and a stator, are preferably used.

Then the pulverized particles are classified. Fine particles are removed therefrom using a cyclone, a decanter and a centrifugal classifier. In addition, coarse particles are removed therefrom using a screen with 250 mesh or more to prepare toner particles having a desired average particle diameter.

The shape and size of the toner of the present invention are not particularly limited. However, the toner particles preferably have the following average circularity, weight average particle diameter and ratio (Dw/Dn) of the weight average particle diameter (Dw) of the toner particles to the number average particle diameter (Dn) of the toner particles.

The toner of the present invention preferably has a circularity of from 0.900 to 0.980, and more preferably from 0.950 to 0.975. In addition, the content of particles having a circularity of less than 0.94 is preferably not greater than 15% by weight.

In the present application, the circularity of a toner is determined by the following method using a flow-type particle image analyzer FPIA-2100 from Sysmex Corp.:
(1) a suspension including toner particles to be measured is passed through a detection area formed on a plate in the measuring instrument; and
(2) the particles are optically detected by a CCD camera and then the shapes thereof are analyzed with an image analyzer.

The circularity of a particle is determined by the following equation:

Circularity=Cs/Cp

wherein Cp represents the length of the circumference of the projected image of a particle and Cs represents the length of the circumference of a circle having the same area as that of the projected image of the particle.

When the average circularity of the toner is too low, the transferability of the toner deteriorates, and thereby high quality images without toner scattering cannot be produced. In contrast, a toner having too high an average circularity tends to cause a cleaning problem in that toner particles remaining on an image bearing member without being transferred cannot be well removed by a cleaning blade, resulting occurrence of the background development problem when images with high image area proportion are produced or toner images are not transferred to a receiving material due to misfeed of the receiving material. In this case, when the residual toner particles are transferred to a charging roller, the charging ability of the charging roller deteriorates, resulting in occurrence of defective charging.

The weight average particle diameter of the toner of the present invention is preferably from 3 to 8 μm, and more preferably from 3 to 7 μm. When the weight average particle diameter is too small, the toner tends to adhere to the surface of carrier particles when agitated in a developing device for a long period of time, thereby deteriorating the charging ability of the carrier, resulting in deterioration of image qualities. When such a small particle diameter toner is used as a one component developer, the toner tends to adhere to developing rollers and blades used for forming a toner layer on developing rollers, resulting in deterioration of image qualities. In contrast, when the weight average particle diameter is too large, high definition images cannot be produced. In this case, a problem in that the particle diameter distribution of the toner varies occurs when the toner is used for a long period of time while replenished to the developing device.

The ratio (Dw/Dn) of the volume average particle diameter (Dw) of the toner to the number average particle diameter (Dn) thereof is preferably from 1.00 to 1.25, and more preferably from 1.10 to 1.15. In this case, the toner has good fixability because of having a sharp particle diameter distribution. When the ratio (Dw/Dn) is too large, the toner tends to adhere to the surface of carrier particles when agitated in a developing device for a long period of time, thereby deteriorating the charging ability and cleanability of the carrier, resulting in deterioration of image qualities. When a toner having too small a ratio (Dw/Dn) is used as a one component developer, the toner tends to adhere to developing rollers and blades used for forming a toner layer on developing rollers, and thereby it becomes difficult to produce high quality and high definition images. In addition, a problem in that the particle diameter distribution of the toner varies occurs when the toner is used for a long period of time while replenished to the developing device.

The average particle diameters Dw and Dn, and the ratio (Dw/Dn) of a toner can be measured using a particle diameter measuring instrument such as COULTER COUNTER TAII from Beckmann Coulter Inc.

The toner of the present invention is at least one of a black toner, a cyan toner, a magenta toner, and a yellow toner. Such a color toner can be obtained by using a proper colorant.

The developer of the present invention may be a one component developer consisting essentially of the toner of the present invention, or a two component developer including the toner and a carrier. When the developer is used for high speed printers, a two component developer is preferably used in view of life, etc. In the two component developer, the weight ratio (T/C) of the toner (T) to a carrier (C) is preferably from 1/100 to 10/100.

When the toner is used as a one component developer, the particle diameter distribution of the toner (developer) hardly varies when the toner is used for a long period of time while replenished to the developing device. In addition, the toner hardly adheres to developing rollers and blades used for forming a toner layer on developing rollers. Therefore, the developer can maintain good developing property, resulting in formation of high quality images.

The two component developer of the present invention including the toner of the present invention hardly causes the problem in that the particle diameter distribution of the toner varies when the toner is used for a long period of time while replenished to the developing device. In addition, even after the developer is agitated in a developing device over a long period of time, the developer can maintain good developing property and therefore high quality images can be produced.

The carrier for use in the two component developer of the present invention is not particularly limited. However, it is preferable to use a carrier which includes a lease a core material and a resin layer formed on the core material.

Suitable materials for use as the core material include manganese-strontium (Mn—Sr) materials and manganese-magnesium (Mn—Mg) materials, which have a saturation magnetization of from 50 to 90 Am²/kg (50 to 90 emu/g). In view of image density, high magnetization materials such as iron powders (having a a saturation magnetization not less than 100 Am²/kg (100 emu/g) and magnetite having a saturation magnetization of from 75 to 120 Am²/kg (75 to 120 emu/g) are preferably used. In addition, low magnetization materials suchas copper-zinc materials having a saturation magnetization of from 30 to 80 Am²/kg (30 to 80 emu/g) can be preferably used because the impact of the magnetic brush against the photoreceptor is relatively weak and high quality images can be produced.

These carrier materials can be used alone or in combination.

The core material of the carrier preferably has a weight average particle diameter of from 10 to 200 μm, and more preferably from 40 to 100 μm. When the weight average particle diameter is too small (i.e., the content of fine carrier particles increases), the magnetization per each particle decreases, resulting in occurrence of a carrier scattering problem. When the particle diameter is too large, the surface area of the carrier per unit weight decreases and thereby a toner scattering problem tends to occur. In addition, another problem in that uneven solid images are formed tends to occur. This problem is remarkably caused when full color images are produced because full color images typically include large solid images.

Specific examples of such resins for use in the resin layer on the core material include amino resins, vinyl resins, polystyrene resins, halogenatedolefinresins, polyesterresins, polycarbonate resins, polyethylene resins, polyvinyl fluoride resins, polyvinylidene fluoride resins, polytrifluoroethylene resins, polyhexafluoropropylene resins, vinylidenefluoride—acrylate copolymers, vinylidenefluoride—vinylfluoride copolymers, copolymers of tetrafluoroethylene, vinylidenefluoride and othermonomers including no fluorine atom, silicone resins, epoxy resins, etc. These resins can be used alone or in combination.

Specific examples of the amino resins include urea—formaldehyde resins, melamine resins, benzoguanamine resins, urea resins, and polyamide resins. Specific examples of the vinyl resins include acrylic resins, polymethylmethacrylate resins, polyacrylonitrile resins, polyvinyl acetate resins, polyvinyl alcohol resins, polyvinyl butyral resins, etc. Specific examples of the polystyrene resins include polystyrene resins and styrene—acrylic copolymers. Specific examples of the halogenated olefin resins include polyvinyl chloride resins. Specific examples of the polyester resins include polyethyleneterephthalate resins and polybutyleneterephthalate resins.

If desired, an electroconductive powder can be included in the resin layer on the core material. Specific examples of such electroconductive powders include metal powders, carbon blacks, titanium oxide, tin oxide, and zinc oxide. The average particle diameter of such electroconductive powders is preferably not greater than 1 μm. When the particle diameter is too large, it is hard to control the electric resistance of the coating layer.

The resin layer can be formed by coating a resin solution, which is prepared by dissolving a resin in a solvent, on a core material using any known coating method, followed by drying and baking. Suitable coating methods include dip coating methods, spray coating methods, brush coating methods, etc.

Specific examples of the solvent include toluene, xylene, methyl ethyl ketone, methyl isobutyl ketone, methyl cellosolve, butyl acetate, etc.

The method of baking the coated layer is not particularly limited, and external heating methods and internal heating methods can be used. For example, methods using a heating device such as fixed electric furnaces, fluid electric furnaces, rotary electric furnaces, and burner furnaces, and methods using microwave, are preferably used.

The weight ratio of the resin layer in the carrier is preferably 0.01 to 5.0% by weight based on the weight of the coated carrier. When the weight ratio is too small, a uniform resin layer cannot be formed. When the weight ratio is too large, the carrier particles agglomerate, and thereby the toner cannot be uniformly charged.

The developer (or toner) of the present invention can be preferably used for known developing methods such as magnetic one component developing methods, non-magnetic one component developing methods, and two component developing methods.

The developer of the present invention is contained in a container. Such a container including the developer is delivered to a user on demand. The container typically has a main body and a cap. The shape, structure, size, material, etc. of the container are not particularly limited. However, a cylindrical container having a spiral groove on the inner surface thereof is preferably used. When such a container is rotated in an image forming apparatus, the developer (or toner) therein is fed toward the exit thereof to be fed to a developing device. In addition, containers with a groove, entire or part of which can be folded like accordion, can be preferably used.

Suitable materials for use as the developer (or toner) container include resins having good dimension stability. Specific examples thereof include polyester resins, polyethylene resins, polypropylene resins, polystyrene resins, polyvinyl chloride resins, acrylic resins, polycarbonate resins, ABS resins, polyacetal resins, etc.

By using such a developer (or toner) container, the developer (or toner) of the present invention is easy to handle, store, and transport. The container is typically used by being detachably set in a process cartridge or an image forming apparatus to replenish the developer (or toner).

Next, the process cartridge and image forming method and apparatus of the present invention will be explained.

The process cartridge of the present invention includes at least a photoreceptor serving as an image bearing member, and a developer device configured to develop an electrostatic image on the photoreceptor to form a toner image thereon. In this regard, the photoreceptor and developing device are integrally supported and the process cartridge is detachably attached to an image forming apparatus. The process cartridge can have other members such as chargers, cleaners and transfer devices.

The developing device includes at least a developer containing portion configured to contain the developer, and a developer bearing member configured to bear and transport the developer. Further, the developing device optionally includes a developer thickness controlling member configured to control the thickness of the developer on the developer bearing member.

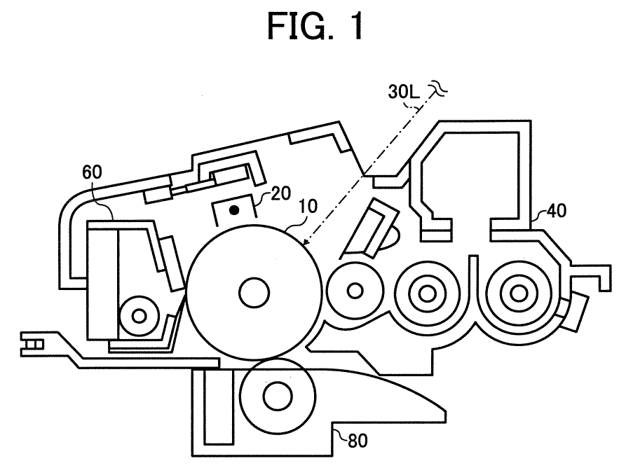

FIG. 1 illustrates an example of the process cartridge of the present invention. The process cartridge include a photoreceptor 10 serving as an image bearing member, a charging device 20 configured to charge the photoreceptor 10, a developing device 40 configured to develop an electrostatic image on the photoreceptor 10 to form a toner image thereon, a cleaning device 60 configured to clean the surface of the photoreceptor 10 and a transfer device 80 configured to transfer the toner image onto a receiving material. Numeral 30L denotes imagewise light emitted from a light irradiating device in an image forming apparatus to form an electrostatic latent image on the photoreceptor 10. These devices will be explained in detain in the below-mentioned explanation of the image forming apparatus of the present invention.

The image forming method of the present invention includes at least steps of forming an electrostatic image on an image bearing member, developing the electrostatic image with the developer of the present invention to form a toner image on the image bearing member, transferring the toner image onto a receiving material, and fixing the toner image on the receiving material. The image forming method optionally include other steps such as discharging charges remaining on the photoreceptor after the transfer step, cleaning toner particles remaining on the photoreceptor after the transfer step, recycling the toner particles collected by the cleaner, and controlling image forming conditions.

The image forming apparatus of the present invention includes at least a photoreceptor, a charging device, a light irradiating device, a developing device, a transfer device and a fixing device. The image forming apparatus optionally includes other devices such as discharging devices, cleaning devices, recycling devices, and controlling devices.

In the electrostatic image forming process, an electrostatic image is formed on the photoreceptor. An electrostatic image can be formed, for example, by applying a voltage to the photoreceptor using a charging device so that the surface of the photoreceptor is uniformly charged, and then irradiating the charged photoreceptor with imagewise light.

The material, shape, structure, size etc. of the photoreceptor are not particularly limited, and any known photoreceptors can be used. For example, inorganic photoreceptors such as amorphous silicon and selenium, and organic photoreceptors such as polysilane and phthalopolymethine can be used. Among these photoreceptors, amorphous silicon is preferably used because of having a long life.

The charging device is not particularly limited, and contact chargers using a roller, a brush, a film or a rubber blade, which is conductive or semi-conductive; and non-contact chargers using a corotron or a scorotron, which utilizes corona discharging, can be used therefor. It is preferable that the charging device charges the photoreceptor by applying a DC voltage overlapped with an AC voltage to the photoreceptor while being contacted with or separated from the photoreceptor. In addition, it is preferable to use a short-range charger, in which a charging roller set in the vicinity of the photoreceptor while a gap tape set on both sides of the charging roller is contacted with the surface of the photoreceptor.

The light irradiating device is not particularly limited as long as the device can irradiate the charged photoreceptor with imagewise light to form an electrostatic latent image on the photoreceptor. For example, optical devices for use in copiers, rodlensarrays, optical devices using a laser, optical devices using a liquid crystal shutter, etc, can be used therefor. Further, it is possible to irradiate the photosensitive layer of the photoreceptor from the inside thereof.

In the developing process, the electrostatic image formed on the photoreceptor is developed with the developer using the developing device. The developing device is not particularly limited so long as the device can develop an electrostatic image using the toner of the present invention, and any known developing devices can be used. For example, developing devices which include a developer containing portion containing the developer of the present invention and a developer bearing member applying the developer to the electrostatic image on the photoreceptor while the developer is contacted with the photoreceptor or is not contacted with the photoreceptor. It is preferable that the above-mentioned developer (or toner) container is detachably attached to the developing device.

The developing device can use a dry developing method or a wet developing method. In addition, the developing device may be a single color developing device of a multi-color developing device. For example, when a dry developing method is used, the developing device includes at least an agitator configured to agitate the developer to charge the developer, and a rotatable magnet roller serving as the developer bearing member. In the developing device, the toner of the present invention and a carrier are mixed while agitated to frictionally charge the toner. The thus charged developer is borne on the surface of the rotated magnet roller while the developer thereon is erected, resulting in formation of a magnetic brush. Since the magnet roller is located in the vicinity of the photoreceptor, the toner particles in the magnetic brush are electrostatically attracted by an electrostatic latent image on the photoreceptor, resulting in transfer of the toner particles to the electrostatic latent image. Thus, atoner image is formed on the photo receptor. It is preferable in the developing process to move toner particles toward an electrostatic image on the photoreceptor by forming an alternating electric field in the development region.

In the transfer process, the toner image is transferred onto a receiving material using the transfer device. It is preferable that the toner image on the photoreceptor is firstly transferred onto an intermediate transfer medium (i.e., primary transfer process), followed by transfer to a receiving material (secondary transfer process). In addition, it is preferable that two or more toner images (preferably four full color toner images) are transferred onto an intermediate transfer medium so as to be overlaid, and the overlaid multi (or full) color toner images are then transferred onto a receiving material. It is possible to charge the photoreceptor in the transfer process to well transfer the toner image.

The transfer device preferably has a primary transfer member configured to transfer a toner image on the photoreceptor to an intermediate transfer medium, and a secondary transfer member configured to transfer the toner image (or images) on the intermediate transfer medium to a receiving material. The transfer device (having primary and secondary transfer members) preferably includes a transfer element configured to charge the toner image on the photoreceptor so as to be easily transferred to an intermediate transfer medium or a receiving material. Specific examples of the transfer element include corona chargers, transfer belts, transfer rollers, pressure transfer rollers, adhesive transfer elements, etc. The transfer device may be constituted of one transfer member or two or more transfer members (such as primary and secondary transfer members).

The intermediate transfer medium is not particularly limited, and known intermediate transfer media can be used. For example, transfer belts can be used therefor.

In addition, the receiving material is not particularly limited, and any known receiving materials such as papers and films can be used.

In the fixing process, the toner image on a receiving material is fixed thereto. When plural toner images are transferred onto a receiving material, a fixing operation can be performed on each toner image or all the toner images.

The fixing device is not particularly limited, but heat/pressure fixing devices are preferably used. The fixing device preferably uses a fixing member such as rollers and films. Particularly, heat/pressure fixing devices using a combination of a heat roller and a pressure roller or a combination of a heat roller, a pressure roller and an endless belt are preferably used. The temperature of the heating member is preferably from 80 to 200° C. In the present invention, a fixing device including a heating member having a heater, a film contacting the heating member, and a pressure member contacting the heating member with the film therebetween can also be used. In this fixing device, a receiving material having a toner image thereon passes between the heated film and the pressure member, resulting in fixation of the toner image on the receiving material.

It is possible to use a light fixing device instead of the above-mentioned fixing devices or in combination of one or more of the above-mentioned fixing devices.

In the discharging process, a bias is applied to the photoreceptor to discharge the charges remaining on the photoreceptor even after the transfer process. The discharging device is not particularly limited, and known dischargers such as discharging lamps can be used.

In the cleaning process, toner particles remaining on the photoreceptor are removed using a cleaner. Any known cleaners such as magnetic brush cleaners, electrostatic brush cleaners, magnetic roller cleaners, blade cleaners, brush cleaners, and web cleaners can be used as the cleaner of the cleaning device.

In the recycling process, the toner particles collected by the cleaning device are fed to the developing device by a recycling device. The recycling device is not particularly limited, and any known powder feeding devices can be used therefor.

In the controlling process, all the image forming processes are controlled using a controller. The controller is not particularly limited, and any known controllers such as sequencers and computers can be used.

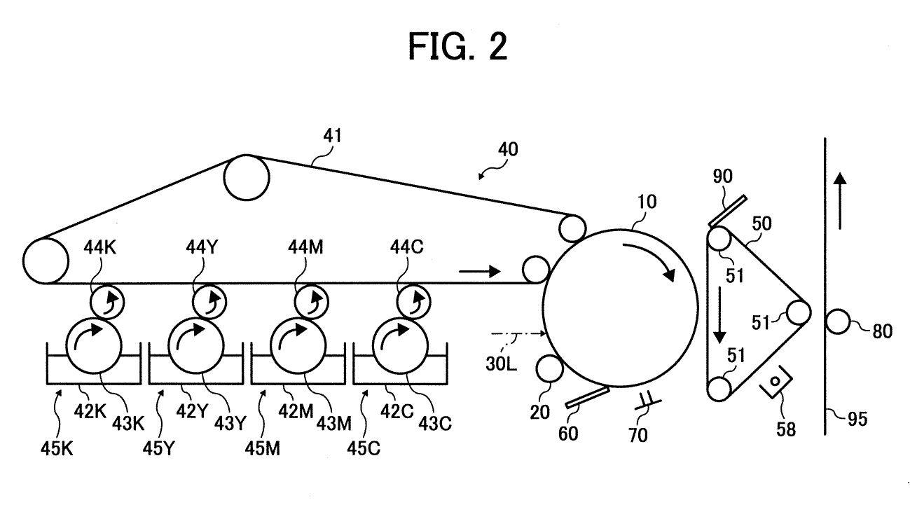

FIG. 2 illustrates an example of the image forming apparatus of the present invention.

Referring to FIG. 2, the image forming apparatus includes the photoreceptor 10, the charging device 20, a light irradiating device emitting imagewise light 30L, the developing device 40, an intermediate transfer medium 50, the cleaning device 60 including a cleaning blade, the discharging device 70 and the transfer device 80. In this image forming apparatus, a charging roller is used for the charging device 20, a discharging lamp is used for the discharging device 70, and a transfer roller is used for the transfer device 80.

The intermediate transfer medium 50 is an endless belt, which is rotated in a direction indicated by a narrow while tightly stretched by three support rollers 51. One or more of the three support rollers 51 serve as a transfer bias roller configured to apply a transfer bias (primary transfer bias) to the intermediate transfer medium 50. A cleaning device 90 having a cleaning blade is provided to clean the surface of the intermediate transfer medium 50.

The transfer device 80, which is arranged to face the intermediate transfer medium 50, applies a secondary transfer bias to a receiving material 95 to well transfer the toner image on the intermediate transfer medium to the receiving material 95. A corona charger 58 is provided in the vicinity of the intermediate transfer medium 50 to charge the toner image on the intermediate transfer medium. The corona charger 58 is located between a primary transfer region, at which the photoreceptor 10 faces the intermediate transfer medium 50, and the secondary transfer region at which the intermediate transfer medium 50 faces the receiving material 95. In this example, the receiving material 95 is a paper sheet.

The developing device 40 includes a developing belt 41 serving as a developer bearing member, and four developing units, i.e., black, yellow, magenta and cyan developing units 45K, 45Y, 45M and 45C. Each developing unit 45 includes a developer containing portion 42 (42K, 42Y, 42M and 42C), a developer supplying roller 43 (43K, 43Y, 43M and 43C), and a developing roller 44 (44K, 44Y, 44M and 44C). The developing belt 41 is an endless belt, which is rotated while tightly stretched by plural rollers and a part of which is contacted with the photoreceptor 10. The developing device can use a wet developer including the toner particles mentioned above and a carrier liquid such as hydrocarbons.

In this example, an image is formed as follows. At first, the charging device 20 uniformly charges the photoreceptor 10. The light irradiating device 30 irradiates the charged photoreceptor with imagewise light to form an electrostatic latent image thereon. The developing device 40 develops the electrostatic latent image with the developer of the present invention on the developing roller to form a toner image on the photoreceptor 10. The toner image is primarily transferred to the intermediate transfer medium 50 due to the bias applied by one or more of the support rollers 51. The toner image is then transferred onto the receiving material 95 (secondary transfer). Toner particles remaining on the photoreceptor 10 without being transferred are removed by the cleaning device 60, and charges remaining on the photoreceptor are removed by the discharging device 70.

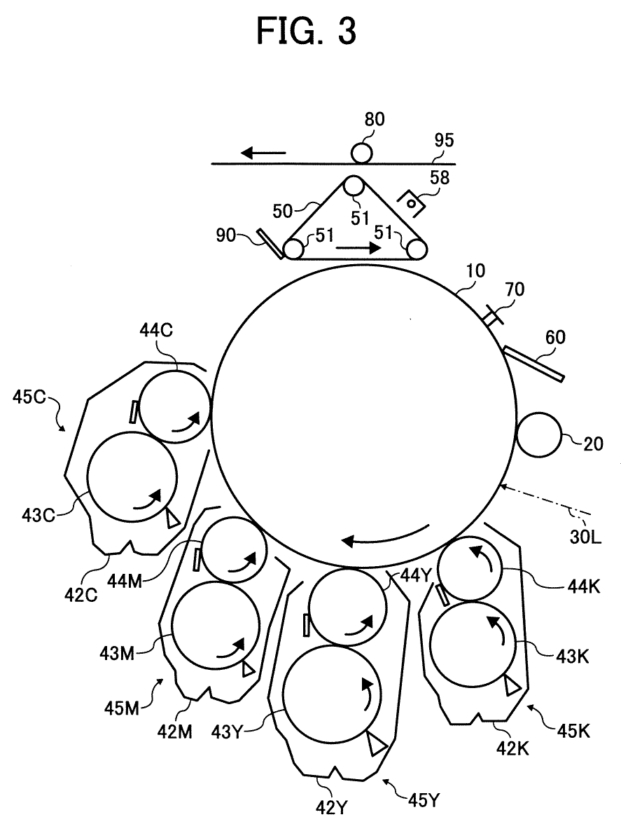

FIG. 3 illustrates another example of the image forming apparatus of the present invention.

The image forming apparatus illustrated in FIG. 3 is the same as the image forming apparatus illustrated in FIG. 2 except that the developing device 40 including the four developing units 45K, 45Y, 45M and 45C faces the photoreceptor 10. In FIGS. 1 to 5, like reference characters designate like corresponding parts, and explanation of the devices mentioned above is omitted here.

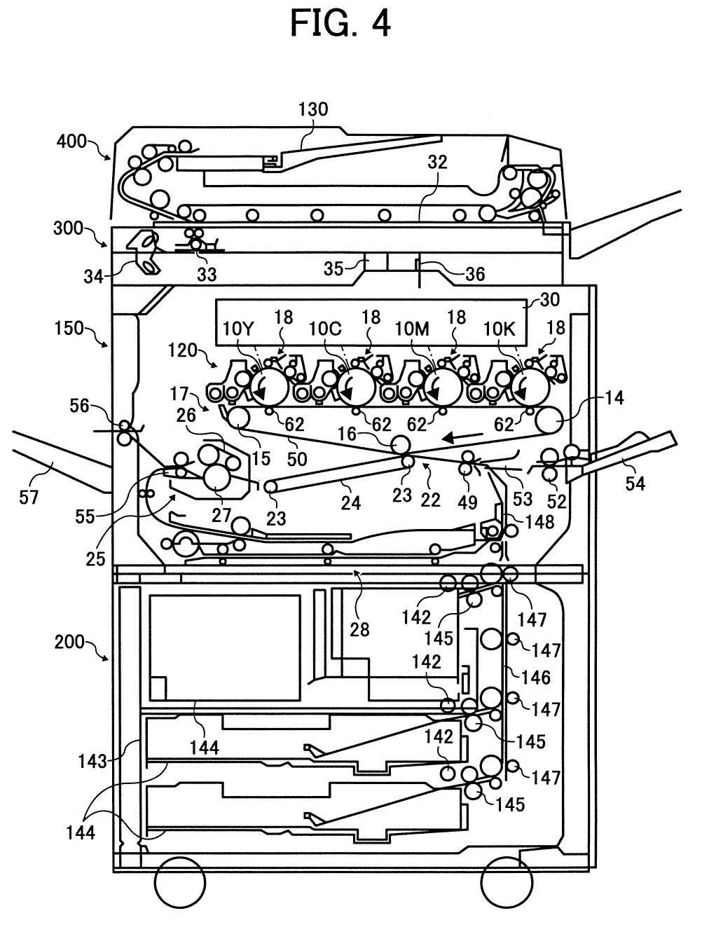

FIG. 4 illustrates a tandem type full color image forming apparatus, which is another example of the image forming apparatus of the present invention.

Referring to FIG. 4, the image forming apparatus includes a main image forming body 150, a receiving material feeding table 200, a scanner 300 and an automatic document feeder (ADF) 400.

The main image forming body 150 includes an intermediate transfer medium 50, which is an endless belt located in the center of the main body 150. The intermediate transfer medium 50 is clockwise rotated while tightly stretched by support rollers 14, 15 and 16. A cleaning device 17 is provided in the vicinity of the support roller 15 to remove toner particles remaining on the intermediate transfer medium 50. An image forming section 120 in which yellow, magenta, cyan and black image forming units 18 are serially arranged in the moving direction of the intermediate transfer medium 50 so as to face a portion of the intermediate transfer medium 50 supported by the support rollers 14 and 15. A light irradiating device 30 is provided in the vicinity of the image forming section 120. A secondary transfer device 22 is provided so as to be contacted with one side of the intermediate transfer medium 50 opposite to the portion thereof facing the image forming section 120. The secondary transfer device 22 includes an endless secondary transfer belt 24 which is tightly stretched by a pair of support rollers 23. The receiving material fed by the secondary transfer belt 24 is contacted with the intermediate transfer medium 50. A fixing device 25 is provided in the vicinity of the secondary transfer device 22. The fixing device 25 includes an endless fixing belt 26 and a pressure roller 27 pressing the fixing belt 26. A reversing device 28 configured to reverse the receiving material to prepare a double-sided copy is provided in the vicinity of the secondary transfer device 22 and the fixing device 25.

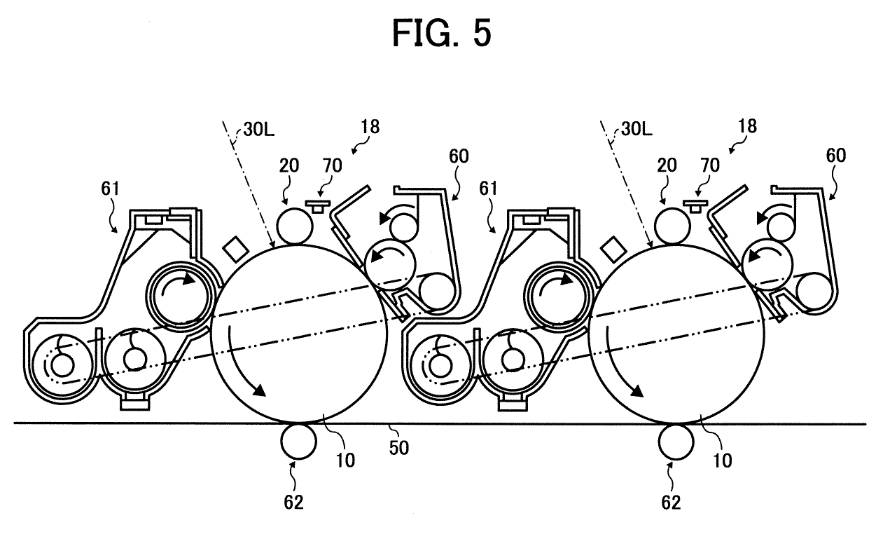

Then the full color image forming operation using the tandem type color image forming apparatus illustrated in FIGS. 4 and 5 will be explained.

An original to be copied is set on an original table 130 of the automatic document feeder 400. Alternatively, the original is directly set on a glass plate 32 of the scanner 300 after the automatic document feeder 400 is opened, followed by closing of the automatic document feeder 400. When a start button (not shown) is pushed, the color image on the original set on the glass plate 32 is scanned with a first traveler 33 and a second traveler 34, which move to the right in FIG. 4. In the case where the original is set on a table of the automatic document feeder 400, at first the original is fed to the glass plate 32, and then the color image on the original is scanned with the first and second travelers 33 and 34. The first traveler 33 irradiates the color image on the original with light and the second traveler 34 reflects the light reflected from the color image to send the color image light to a sensor 36 via a focusing lens 35. Thus, color image information (i.e., black, yellow, magenta and cyan color image data) is provided.

The black, yellow, magenta and cyan color image data are sent to the respective black, yellow, magenta and cyan color image forming units 18, and black, yellow, magenta and cyan color toner images are formed on the respective photoreceptors 10K, 10Y, 10M and 10C.

FIG. 5 is a schematic view illustrating a part of the image forming units 18.

Each of the image forming unit 18 includes the photoreceptor 10, charging device 20 charging the photoreceptor 10, a developing device 61 configured to develop an electrostatic image on the photoreceptor 10 with the corresponding color developer (black, yellow, magenta or cyan color developer) to form a color toner image thereon, a transfer charger 62 configured to charge the toner image so that the toner image can be well transferred onto the intermediate transfer medium 50, the cleaning device 60 and the discharging device 70. Then image forming units 18 form color images on the respective photoreceptors 10 according to the corresponding color image data.

Referring back to FIG. 4, the thus prepared black, yellow, magenta and cyan color toner images are transferred one by one to the intermediate transfer medium 50, resulting in formation of a full color toner image on the intermediate transfer medium 50.

In the paper feeding section 200, one of paper feeding rollers 142 is selectively rotated to feed the uppermost paper sheet of paper sheets stacked in a paper cassette 144 in a paper bank 143 while the fed paper sheets are separated one by one by a separation roller 145 when plural paper sheets are continuously fed. The paper sheet is fed to a passage 148 in the image forming section 150 through a passage 146 in the paper feeding section 200, and is stopped once by a registration roller 49. Numeral 147 denotes feed rollers. A paper sheet can also be fed from a manual paper tray 54 to a passage 53 by a separation roller and a pair of rollers 52. The thus fed paper sheet is also stopped once by the registration roller 49. The registration roller 49 is generally grounded, but a bias can be applied thereto to remove paper dust therefrom.

The thus prepared full color toner image on the intermediate transfer medium 50 is transferred to the paper sheet, which is timely fed by the registration roller 49, at the contact point of the second transfer device 22 and the intermediate transfer medium 50. Toner particles remaining on the surface of the intermediate transfer medium 50 even after the second image transfer operation are removed therefrom by the cleaning device 17.

The paper sheet having the full color toner image thereon is then fed by the second transfer device 22 to the fixing device 25, and the toner image is fixed on the paper sheet upon application of heat and pressure thereto. Then the paper sheet is discharged from the image forming section 150 by a discharge roller 56 while the path is properly selected by a paper path changing pick 55. Thus, a copy is stacked on a tray 57. When a double-sided copy is produced, the paper sheet having a toner image on one side thereof is fed to the reversing device 28 to be reversed. Then the paper sheet is fed to the second transfer device 24 so that an image is transferred to the other side of the paper sheet. The image is also fixed by the fixing device 25 and then the double-sided copy is discharged to the tray 57 by the discharge roller 56.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Preparation of Toner Particles (1)

In a reaction vessel equipped with a stirrer and a thermometer, 683 parts of water, 11 parts of a sodium salt of sulfate of an ethylene oxide adduct of methacrylic acid (ELEMINOL RS-30 from Sanyo Chemical Industries Ltd.), 83 parts of styrene, 83 parts of methacrylic acid, 110 parts of butyl acrylate, and 1 part of ammonium persulfate were mixed. The mixture was agitated for 15 minutes while the stirrer was rotated at a revolution of 400 rpm. As a result, a milky emulsion was prepared. Then the emulsion was heated to 75° C. to react the monomers for 5 hours.

Further, 30 parts of a 1% by weight aqueous solution of ammonium persulfate was added thereto, and the mixture was aged for 5 hours at 75° C. Thus, an aqueous dispersion of a vinyl resin (i.e., a copolymer of styrene/methacrylic acid/butyl acrylate/sodium salt of sulfate of ethylene oxide adduct of methacrylic acid, hereinafter referred to as particulate resin dispersion (1)) was prepared.

The weight average particle diameter of the particles in the particulate resin dispersion (1), which was measured with an instrument LA-920 from Horiba Ltd. utilizing a laser light scattering method, was 105 nm. In addition, part of the particulate resin dispersion (1) was dried to prepare a solid of the vinyl resin. It was confirmed that the vinyl resin has a glass transition temperature of 59° C. and a weight average molecular weight of 150,000.

### Preparation of Aqueous Phase Liquid

In a reaction vessel equipped with a stirrer, 990 parts of water, 83 parts of the particulate resin dispersion (1) prepared above, 37 parts of an aqueous solution of a sodium salt of dodecyldiphenyletherdisulfonic acid (ELEMINOL MON-7 from Sanyo Chemical Industries Ltd., solid content of 48.5%), and 90 parts of ethyl acetate were mixed while agitated. As a result, a milky liquid (hereinafter referred to as an aqueous phase liquid (1)) was prepared.

### Preparation of Low Molecular Weight Polyester Resin

The following components were contained in a reaction vessel equipped with a condenser, a stirrer and a nitrogen feed pipe and the mixture was subjected to a polycondensation reaction for 8 hours at 230° C. under a normal pressure.

| | |
|---|---|
| Ethylene oxide (2 mole) adduct of | 229 parts |
| bisphenol A | |
| Propylene oxide (3 mole) adduct of | 529 parts |
| bisphenol A | |
| Terephthalic acid | 208 parts |
| Adipic acid | 46 parts |
| Dibutyltin oxide | 2 parts |

Then the reaction was further continued for 5 hours under a reduced pressure of from 10 to 15 mmHg.

Further, 44 parts of trimellitic anhydride was fed to the container to be reacted with the reaction product for 2 hours at 180° C. under a normal pressure. Thus, a low molecular weight polyester resin (1) was prepared. The low molecular weight polyester resin (1) has a number average molecular weight of 2600, a weight average molecular weight of 5800, a glass transition temperature (Tg) of 45° C. and an acid value of 24 mgKOH/g.

### Preparation of Polyester Prepolymer

The following components were contained in a reaction vessel equipped with a condenser, a stirrer and a nitrogen feed pipe and reacted for 8 hours at 230° C. under a normal pressure.

| | |
|---|---|
| Ethylene oxide (2 mole) adduct of | 682 parts |
| bisphenol A | |
| Propylene oxide (2 mole) adduct of | 81 parts |
| bisphenol A | |
| Terephthalic acid | 283 parts |
| Trimellitic anhydride | 22 parts |
| Dibutyl tin oxide | 2 parts |

Then the reaction was further continued for 5 hours under a reduced pressure of from 10 to 15 mmHg. Thus, an intermediate polyester resin (1) was prepared. The intermediate polyester (1) has a number average molecular weight of 2100, a weight average molecular weight of 9500, a glass transition temperature (Tg) of 55° C., an acid value of 0.5 mgKOH/g and a hydroxyl value of 51 mgKOH/g.

In a reaction vessel equipped with a condenser, a stirrer and a nitrogen feed pipe, 410 parts of the intermediate polyester resin (1), 89 parts of isophorone diisocyanate and 500 parts of ethyl acetate were mixed and the mixture was heated at 100 ° C. for 5 hours to perform the reaction. Thus, a polyester prepolymer (1) having an isocyanate group was prepared. The amount of isocyanate groups included in the polyester prepolymer (1) was 1.74% by weight.

### Synthesis of Ketimine Compound

In a reaction vessel equipped with a stirrer and a thermometer, 170 parts of isophorone diamine and 75 parts of methyl ethyl ketone were mixed and reacted for 5 hours at 50° C. to prepare a ketimine compound (1). The ketimine compound (1) has an amine value of 418 mgKOH/g.

### Preparation of Masterbatch

The following components were mixed using a HENSCHEL MIXER (trademark) mixer from Mitsui Mining Co., Ltd.

| | |
|---|---|
| Water | 1200 parts |
| Carbon black (Pigment Black 7) | 540 parts |
| (PRINTEX 60 from Degussa AG, DBP | |
| oil absorption of 114 ml/100 mg, | |
| pH of 10) | |
| Polyester resin | 1200 parts |

### (RS801 from Sanyo Chemical Industries, Ltd.)

The mixture was kneaded for 30 minutes at 150° C. using a two roll mill. Then the kneaded mixture was cooled by rolling, followed by pulverization. Thus, a masterbatch (1) was prepared.

### Preparation of Oil Phase Liquid

In a reaction vessel equipped with a stirrer and a thermometer, 300 parts of the low molecular weight polyester resin (1), 90 parts of carnauba wax, 10 parts of rice wax and 1000 parts of ethyl acetate were mixed and the mixture was heated to 79° C. while agitated. Then the mixture was rapidly cooled to 4° C. The mixture was subjected to a dispersion treatment using a bead mill (ULTRAVISCOMILL from Aimex Co., Ltd.). The dispersing conditions were as follows.

Liquid feeding speed: 1 kg/hour

Peripheral speed of disc: 6 m/sec

Dispersion media: zirconia beads with a diameter of 0.5 mm

Filling factor of beads: 80% by volume

Repeat number of dispersing operation: 3 times (3 passes)

Thus, a wax dispersion having a weight average particle diameter of 0.6 μm was prepared.

Then 500 parts of the masterbatch (1) and 640 parts of a 70% ethylacetate solutionof thelow molecularweight polyester resin (1) were added to the vessel and the mixture was mixed in the vessel for 10 hours. Further, the mixture was subjected to a dispersion treatment using the bead mill, wherein the dispersing operation was repeated five times. Then ethyl acetate was added to the dispersion to control the solid content of the dispersion to be 50% by weight. Thus, an oil phase liquid (1) was prepared.

### Emulsification

Then the following components were fed in a vessel.

| | |
|---|---|
| Oil phase liquid (1) prepared above | 73.2 parts |
| Prepolymer (1) prepared above | 6.8 parts |
| Ketimine compound (1) prepared above | 0.48 parts |

The components were mixed.

Then 120 parts of the aqueous phase liquid (1) was added thereto and the mixture was mixed for 1 minute using the TK HOMO MIXER mixer, followed by agitation for 1 hour using a paddle. Thus, an emulsion (1) was prepared.

### Preparation of Toner Particles

The emulsion (1) was subjected to a solvent removing treatment for 1 hour at 30° C., followed by aging for 5 hours at 60° C. Then the resultant particles were washed with water, followed by filtration and drying. The particles were sieved using a screen having openings of 75 μm. Thus, black toner particles (1) having a weight average particle diameter of 6.1 μm, a number average particle diameter of 5.4 μm and an average circularity of 0.987 were prepared.

### Preparation of Toner Particles (2)

The following components were kneaded at 120° C. using a heat roller.

| | |
|---|---|
| Polyester resin | 100 parts |
| (weight average molecular weight of 12,000) | |
| Copper phthalocyanine pigment | 2 parts |
| Charge controlling agent having | 2 parts |
| the following formula | |
| 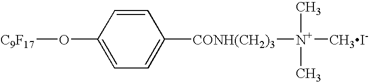 | |

The kneaded mixture was then cooled to be solidified, followed by pulverization and classification. Thus, toner particles (2) having a weight average particle diameter of 7.1 μm, a number average particle diameter of 5.0 μm and an average circularity of 0.921 were prepared.

### Preparation of Toner Particles (3)

The following components were kneaded at 120° C. using a heat roller.

| | |
|---|---|
| Polyester resin (weight average molecular weight of 12,000) | 100 parts |
| Carbon black | 5 parts |
| Chromium-containing dye | 2 parts |

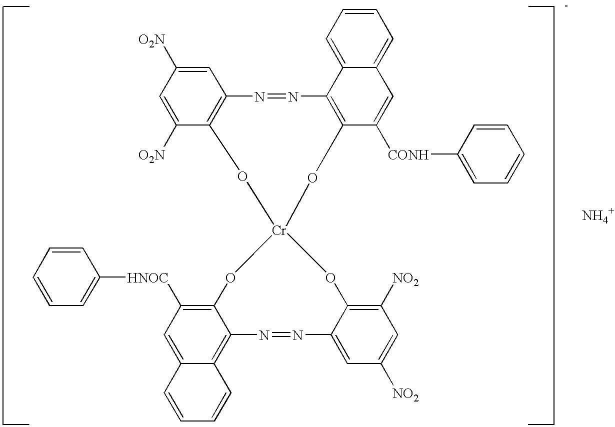

The kneaded mixture was then cooled to be solidified, followed by pulverization and classification. Thus, toner particles (3) having a weight average particle diameter of 7.3 μm, a number average particle diameter of 5.1 μm and an average circularity of 0.917 were prepared.

### Example 1

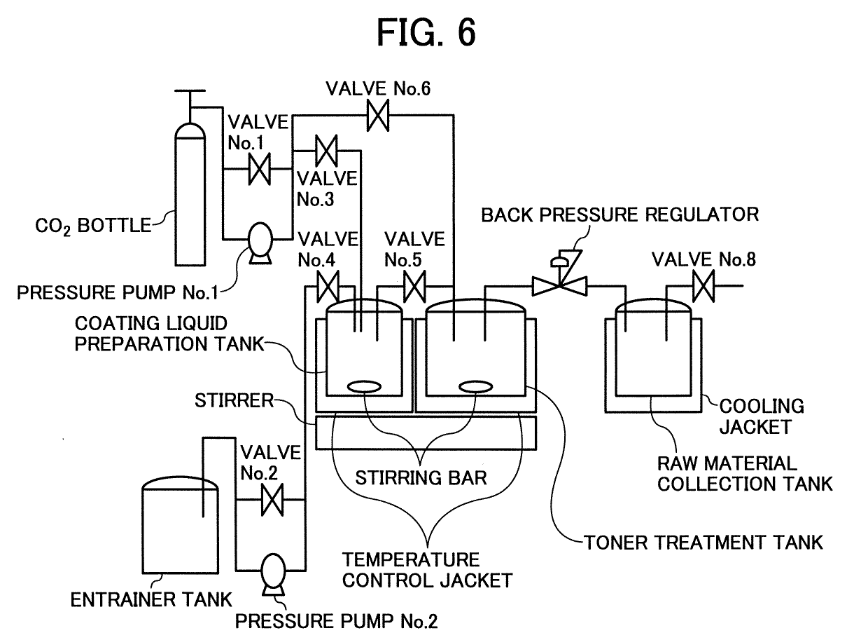

The following components were fed into a 200-ml coating liquid preparation tank of a coating liquid preparation system illustrated in FIG. 6 to prepare a coating liquid.

| | |
|---|---|
| Silicone resin (a) | 200 parts |
| (SR-213 from Dow Corning Taray | |
| Silicone Co., Ltd., having | |
| a weight average molecular weight | |
| of about 4,000, from which | |
| the solvent is removed) | |
| Catalyst (b) having the following formula | 10 parts |
| Sn(CH₃)₂(OCOCH₃)₂ | |

The coating liquid was agitated by a stirring bar rotated by a stirrer.

On the other hand, 500 parts of the toner particles 1 were fed into a toner treatment tank having a volume of 400 ml while agitated by a stirring bar rotated by the stirrer.

Next, valves Nos. 3 and 6 were opened to supply carbon dioxide having a purity of 99.5% (from Ohta Sanso) to the coating liquid preparation tank and the toner treatment tank using a pressure pump No. 1. After the pressure and temperature in the coating liquid preparation tank and the toner treatment tank were controlled so as to be 25 MPa and 80° C., the valve No. 6 was closed. Then valves Nos. 5, and 8 were opened and a valve No. 1 and a back pressure regulator were adjusted, to flow supercritical carbon dioxide into the coating liquid preparation tank and the toner treatment tank for 1 hour at a flow rate of 1 litter per minute (when measured under a normal pressure condition) while the pressure and temperature in the coating liquid preparation tank was controlled so as to be 25 MPa and 80° C., respectively. Further, the valve No. 3 was closed while the back pressure regulator was adjusted so that the pressure of the coating liquid preparation tank was changed to a normal pressure over 15 minutes.

The toner particles (1) thus treated with the silicone resin were then heated for 48 hours at 80° C. to crosslink the silicone resin. Thus, a toner was prepared. The coating liquid, which remained in the coating liquid preparation tank and which was fed to a raw material collection tank without being used for coating, could be collected and reused.

### Example 2

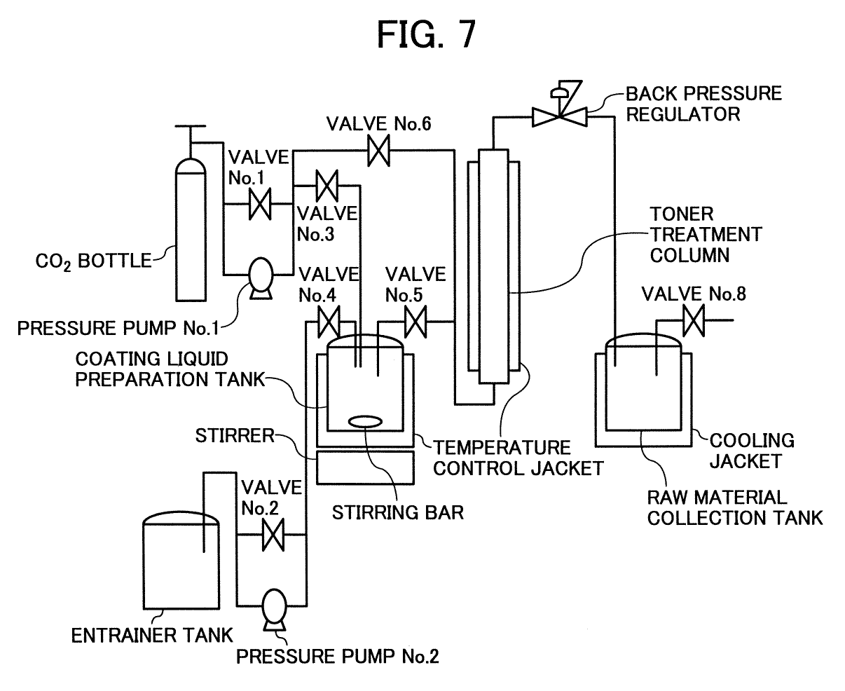

The following components were fed into a 100-ml coating liquid preparation tank of a coating liquid preparation system illustrated in FIG. 7 to prepare a coating liquid.

| | |
|---|---|
| Silicone resin (a) | 200 parts |
| Catalyst (b) | 10 parts |

The coating liquid was agitated by a stirring bar rotated by a stirrer.

On the other hand, 500 parts of the toner particles 1 were fed into a toner treatment column having a volume of 125 ml.

Next, valves Nos. 3 and 6 w ere opened to supply carbon dioxide having a purity of 99.5% (from Ohta Sanso) to the coating liquid preparation tank and the toner treatment column using a pressure pump No. 1. After the pressure and temperature in the coating liquid preparation tank and the toner treatment column were controlled so as to be 25 MPa and 60° C., a valve No. 6 was closed. Then valves Nos. 5, and 8 were opened and a valve No. 1 and a back pressure regulator were adjusted, to flow super critical carbon dioxide into the coating liquid preparation tank and the toner treatment column for 1 hour at a flow rate of 1 litter per minute (when measured under a normal pressure condition) while the pressure and temperature in the coating liquid preparation tank was controlled so as to be 25MPa and 60° C. Further, the valve No. 3 was closed while the back pressure regulator was adjusted so that the pressure of the coating liquid preparation tank was changed to a normal pressure over 2 hours.

The toner particles (1) thus treated with the silicone resin were then heated for 72 hours at 60° C. to crosslink the silicone resin. Thus, a toner was prepared. The coating liquid, which remained in the coating liquid preparation tank and which was fed to a raw material collection tank without being used for coating, could be collected and reused.

### Example 3

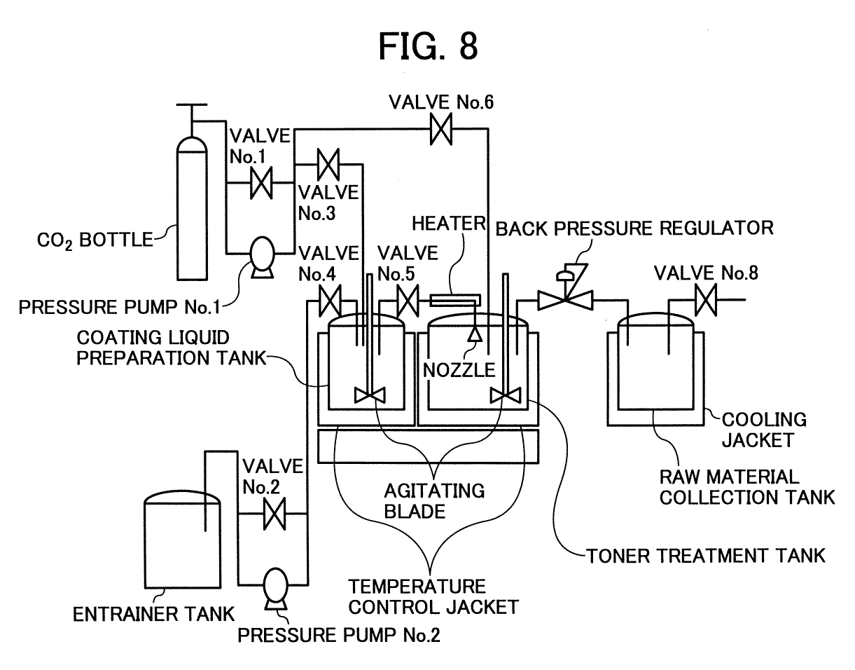

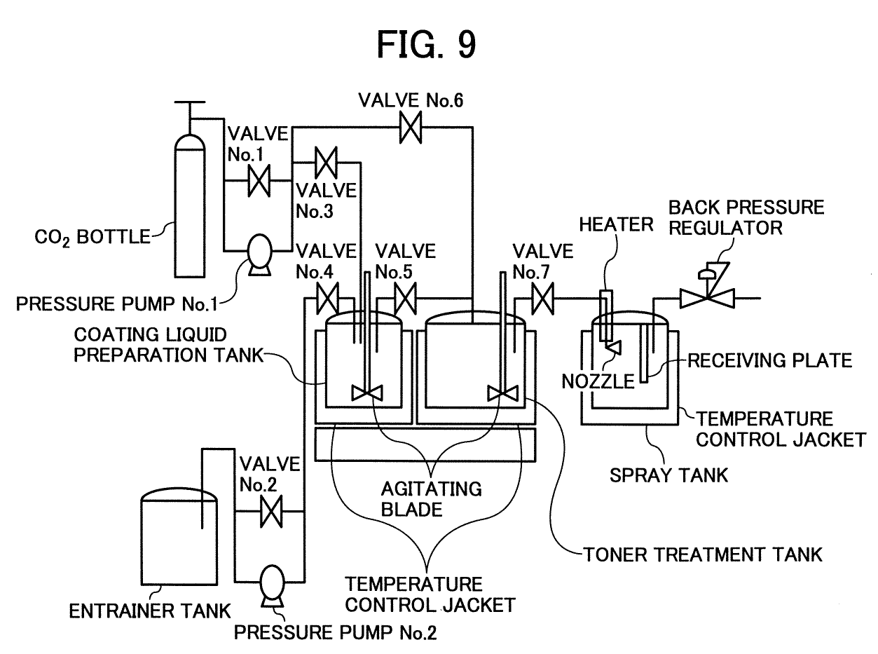

The following components were fed into a 500-milliliter coating liquid preparation tank of a coating liquid preparation system illustrated in FIG. 8 to prepare a coating liquid.

| | |
|---|---|
| Silicone resin (a) | 100 parts |
| Catalyst (b) | 5 parts |

The coating liquid was agitated by an agitating blade. Next, valve No. 3 was opened to supply carbon dioxide having a purity of 99.5% (from Ohta Sanso) to the coating liquid preparation tank using a pressure pump No. 1 while agitating the coating liquid to control the pressure and temperature in the coating liquid preparation tank to be 35 MPa and 40° C., respectively. Thus, a coating liquid was prepared.

Next, 500 parts of the toner particles 1 were fed into a toner treatment tank having a volume of 1000 ml. Then a valve No. 6 was opened to supply carbon dioxide having a purity of 99.5% (from Ohta Sanso) to the toner treatment tank so that the pressure and temperature in the toner treatment tank are 3 MPa and 40° C., respectively. After the valve No. 6 was closed, valves Nos. 5, and 8 were opened while a valve No. 1 and a back pressure regulator were adjusted to control the pressure in the toner treatment tank to be not greater than 7 MPa and the mixture was agitated. Thus the coating liquid was coated on the toner particles (1) for about 40minutes. The toner particles (1) thus treated by the silicone resin were then heated for 120 hours at about 40° C. to crosslink the silicone resin. Thus, a toner was prepared. The coating liquid, which remained in the coating liquid preparation tank and which was fed to a raw material collection tank without being used for coating, could be collected and reused.

### Example4

The following components were fed into a 500-milliliter coating liquid preparation tank of a coating liquid preparation system illustrated in FIG. 8 to prepare a coating liquid.

| | |
|---|---|
| Silicone resin (a) | 50 parts |
| Catalyst (b) | 2.5 parts |

The coating liquid was agitated by an agitating blade.

On the other hand, 500 parts of the toner particles 1 were fed into a toner treatment tank having a volume of 1000 ml.

Next, valves Nos. 3 and 5 were opened to supply carbon dioxide having a purity of 99.5% (from Ohta Sanso) to the coating liquid preparation tank and the toner treatment tank using a pressure pump No. 1. After the pressure and temperature in the coating liquid preparation tank and the toner treatment tank were controlled so as to be 15 MPa and 65° C., the mixture was agitated by an agitator. Thus, a dispersion was prepared. The dispersion was sprayed by a nozzle to be rapidly expanded in a spray tank which is controlled at 30° C. and a normal pressure. The toner particles (1) thus treated by the silicone resin were then heated for 120 hours at about 50° C. to crosslink the silicone resin. Thus, a toner was prepared. The coating liquid, which remained in the coating liquid preparation tank and which was fed to a raw material collection tank without being used for coating, could be collected and reused.

### Example 5

The procedure for preparation of the toner in Example 1 was repeated except that the silicone resin (a) was replaced with an epoxy-modified silicone resin SR2115 from Dow Corning Toray Silicone Co., Ltd., and the pressure and temperature in the treatment were changed to 30 MPa and 70° C.

Thus, a toner was prepared.

### Example 6

The procedure for preparation of the toner in Example 1 was repeated except that the silicone resin (a) was replaced with a silicone resin KR271 from Shin-Etsu Chemical Co., Ltd., and the pressure and temperature in the treatment were changed to 35 MPa and 90 ° C.

Thus, a toner was prepared.

### Example 7

The procedure for preparation of the toner in Example 1 was repeated except that the silicone resin (a) was replaced with a silicone resin 249 FLAKE RESIN from Dow Corning Toray Silicone Co., Ltd., which includes silanol groups and silicon dioxide groups in amounts of 5% and 63%, respectively, and has a crosslinking degree of 71% and a molecular weight of from 2000 to 4000, and the pressure and temperature in the treatment were changed to 20 MPa and 60° C.

Thus, a toner was prepared.

### Example 8

The procedure for preparation of the toner in Example 1 was repeated except that the pressure and temperature in the treatment were changed to 30 MPa and 80° C.

Thus, a toner was prepared.

### Example 9

The procedure for preparation of the toner in Example 1 was repeated except that the silicone resin a was replaced with a silicone resin 233 FLAKE RESIN from Dow Corning Toray Silicone Co., Ltd., which includes silanol groups and silicon dioxide groups in amounts of 5% and 52%, respectively, and has a crosslinking degree of 71% and a molecular weight of from 2000 to 4000, and the pressure and temperature in the treatment were changed to 25 MPa and 65° C.

Thus, a toner was prepared.

### Example 10

The procedure for preparation of the toner in Example 1 was repeated except that 2.5 parts of an aminosilane coupling agent having a formula of NH₂(CH₂)₃Si(OCH₃)₃ was added to the coating liquid preparation tank.

Thus, a toner was prepared.

### Example 11

The procedure for preparation of the toner in Example 4 was repeated except that the silicone resin (a) was replaced with a silicone resin 217 FLAKE RESIN from Dow Corning Toray Silicone Co., Ltd., which includes silanol groups and silicon dioxide groups in amounts of 6% and 46%, respectively, and has a crosslinking degree of 75% and a molecular weight of from 1500 to 2500, ethanol was contained in an entrainer tank, and the conditions were changed as follows:
(1) a valve No. 4 was opened and a pressure pump No. 2 was operated to mix ethanol with carbon dioxide in a weight ratio of 0.5/99.5 (i.e., 5 g/l in the coating liquid preparation tank); and
(2) the temperature in the spray tank was changed to 50° C. (normal pressure).

Thus, a toner was prepared.

### Example 12

The procedure for preparation of the toner in Example 11 was repeated except that the silicone resin 217 FLAKE RESIN was replaced with a silicone resin 220 FLAKE RESIN from Dow Corning Toray Silicone Co., Ltd., which includes silanol groups and silicon dioxide groups in amounts of 6% and 51%, respectively, and has a crosslinking degree of 70% and a molecular weight of from 2000 to 4000, ethanol was replaced with methanol and the weight ratio of methanol to carbon dioxide was controlled to be 5/95.

Thus, a toner was prepared.

### Example 13

The procedure for preparation of the toner in Example 11 was repeated except that the silicone resin 217 FLAKE RESIN was replaced with a silicone resin 233 FLAKE RESIN from Dow Corning Toray Silicone Co., Ltd., ethanol was replaced with propanol and the weight ratio of propanol to carbon dioxide was controlled to be 1/99.

Thus, a toner was prepared.

### Example 14

The procedure for preparation of the toner in Example 1 was repeated except that the toner particles (1) were replaced with the toner particles (2).

Thus, a toner was prepared.

### Example 15

The procedure for preparation of the toner in Example 1 was repeated except that the toner particles (1) were replaced with the toner particles (3).

Thus, a toner was prepared.

### Comparative Example 1

One hundred (100) parts of the toner particles (1) were mixed with 1.5 parts of a hydrophobic silica, which had been treated with hexamethyldisilazane and which has a hydrophobicity of 65%, an average primary particle diameter of 12 nm and a BET specific surface area of 150 m²/g, for 5 minutes using a HENSCHEL MIXER mixer, which was rotated at a peripheral speed of 8 m/sec. Then the mixture was sieved using a screen having openings of 100 μm to remove coarse particles.

Thus, a comparative toner was prepared.

### Comparative Example 2

One hundred (100) parts of the toner particles (2) were mixed with 1.5 parts of a hydrophobic silica, which had been treated with hexamethyldisilazane and which has a hydrophobicity of 65%, an average primary particle diameter of 12 nm and a BET specific surface area of 150 m²/g, for 5 minutes using a HENSCHEL MIXER mixer, which was rotated at a peripheral speed of 8 m/sec. Then the mixture was sieved using a screen having openings of 100 μm to remove coarse particles.

Thus, a comparative toner was prepared.

### Comparative Example 3

One hundred (100) parts of the toner particles (1) were mixed with 1.5 parts of a hydrophobic silica, which had been treated with hexamethyldisilazane and which has a hydrophobicity of 65%, an average primary particle diameter of 12 nm and a BET specific surface area of 150 m²/g, and 0.5 parts of a hydrophobic titanium oxide, which was treated with isobutyl trimethoxysilane and which has a hydrophobicity of70%, anaverage primaryparticle diameter of 15 nm and a BET specific surface area of 58 m²/g, for 10 minutes using a HENSCHEL MIXER mixer, which was rotated at a peripheral speed of 8 m/sec. Then the mixture was sieved using a screen having openings of 100 μm to remove coarse particles.

Thus, a comparative toner was prepared.

### Comparative Example 4

One hundred (100) parts of the toner particles (3) were mixed with 1.5 parts of a hydrophobic silica, which had been treated with hexamethyldisilazane and which has a hydrophobicity of 65%, an average primary particle diameter of 12 nm and a BET specific surface area of 150 m²/g, for 1 minute using a hybridizer, (HYBRIDIZATION SYSTEM from Nara Kikai Co., Ltd.) under a condition of 200 m/sec in peripheral speed. Next, the mixture was mixed with 0.5 parts of a hydrophobic titanium oxide, which had been treated with isobutyl trimethoxysilane and which has a hydrophobicity of 70%, an average primary particle diameter of 15 nm and a BET specific surface area of 58 m²/g, for 1 minute using the hybridizer under a condition of 200 m/sec in peripheral speed. Then the mixture was sieved using a screen having openings of 100 μm to remove coarse particles.

Thus, a comparative toner was prepared.

### Preparation of Carrier

The following components were mixed.

| | |
|---|---|
| Toluene | 200 parts |
| Silicone resin | 200 parts |
| (SR2400 from Dow Corning Toray Silicone Co., Ltd., solid | |
| content of 50% by weight) | |
| Aminosilane | 7 parts |
| (SH6020 from Dow Corning Toray Silicone Co., Ltd.) | |
| Carbon black | 4 parts |

The mixture was agitated with a stirrer for 10 minutes to prepare a coating liquid.

Next, 5000 parts of a manganese ferrite having a weight average particle diameter of 35 μm, which serves as a core, and the coating liquid prepared above were mixed in a coating device which has a fluidized bed, a rotatable bottom disc and an agitating blade and in which swirling flow is formed in the fluidized bed by the rotatable bottom disc and agitating blade. The coated manganese ferrite was then baked for 2 hours at 250° C. in an electric furnace. Thus, a coated carrier was prepared.

### Preparation of Developers

Seven (7) parts of each of the toners was mixed with 100 parts of the coated carrier using a TURBULA MIXER mixer to prepare two component developers.

### Evaluation of Developers

Each of the two component developers was set in an image forming apparatus, IPSIO COLOR 8100 from Ricoh Co., Ltd., and images were produced. The image qualities and the properties of the developers (i.e., toners) were evaluated as mentioned below.

In addition, each of the toners was set in an image forming apparatus, IPSIO COLOR 2000 from Ricoh Co., Ltd., to serve as a one component developer, and images were produced. The image qualities and the properties of the developers (i.e., toners) were evaluated as mentioned below.
1. Image Density

A solid image having a relatively low weight of 0.3±0.1 mg/cm² was formed on a receiving paper TYPE 6200 from Ricoh Co., Ltd. The image density of the solid image was measured with a densitometer X-RITE from X-Rite Inc. The image density was graded into the following three categories.
◯: Image density is not lower than 1.4. (good)
Δ: Image density is not lower than 1.35 and lower than 1.4.
X: Image density is lower than 1.35. (bad)

### 2. Cleanability

One thousand (1,000) copies of an original image having an image area proportion of 95% were produced. Toner particles remaining on a surface of the photoreceptor even after a cleaning process were transferred to a piece of an adhesive tape (SCOTCH TAPE from Sumitomo 3M Ltd.). The piece of the adhesive tape bearing the toner particles thereon and a piece of the adhesive tape bearing no toner particles thereon were attached to a white paper, and the optical densities of the pieces of the adhesive tape were measured with a reflection densitometer RD514 from Macbeth Co. to determine the difference between the optical densities. The cleanability of the toner was graded into the following four categories.
⊚: The optical density difference is lower than 0.005. (excellent)
◯: The optical density difference is not lower than 0.005 and lower than 0.01.
Δ: The optical density difference is not lower than 0.01 and lower than 0.02.
X: The optical density difference is not lower than 0.02. (bad)

### 3. Transferability

A toner image having an image area proportion of 20% was produced on a surface of the photoreceptor and the toner image was transferred onto a receiving paper. Toner particles remaining on a surface of the photoreceptor just before a cleaning process were transferred to a piece of an adhesive tape (SCOTCH TAPE from Sumitomo 3M Ltd.). The piece of the adhesive tape bearing the toner particles thereon and a piece of the adhesive tape bearing no toner particles thereon were attached to a white paper, and the optical densities of the pieces of the adhesive tape were measured with a reflection densitometer RD514 from Macbeth Co. to determine the difference between the optical densities. The transferability of the toner was graded into the following four categories.
⊚: The optical density difference is lower than 0.005. (excellent)
◯: The optical density difference is not lower than 0.005 and lower than 0.01.
Δ: The optical density difference is not lower than 0.01 and lower than 0.02.
X: The optical density difference is not lower than 0.02. (bad)

### 4. Toner Scattering

Each toner was set in an image forming apparatus IPSIO COLOR 8100 from Ricoh Co., Ltd., which had been modified so as to have an oil-less fixing device, and 100,000 copies of an original image having an image area proportion of 5% were continuously produced. Then the inside of the image forming apparatus was visually observed to determine whether the inside is contaminated by scattered toner particles. The toner scattering property was graded into the following four categories.
⊚: The inside is not contaminated. (excellent)
◯: The inside is hardly contaminated.
Δ: The inside is slightly contaminated, but it is still acceptable.
X: The inside is contaminated to an extent such that it causes a problem when the toner is practically used. (bad)

### 5. Charge Stability

A running test in which 100,000 copies of an original character image having an image area proportion of 12% are continuously produced was performed. Before and after the running test, the developer on the developing sleeve was sampled to measure the charge quantity of the developer by a blow-off method and the difference between the charge quantities before and after the running test was determined. The charge stability was graded into the following four categories.
⊚: The charge quantity change is less than 5 μC/g. (good)
Δ: The charge quantity change is not less than 5 μC/g and less than 10 μC/g.
X: The charge quantity change is not less than 10 μC/g. (bad)

### 6. Resistance to Filming

After 1,000 copies of an original image having three band-shaped solid images having image area proportions of 100%, 75% and 50%, the surfaces of the developing roller and the photoreceptor were visually observed to determine whether a film is formed thereon. The filming property was graded into the following four categories.
⊚: A film is not formed thereon. (excellent)
◯: A thin film is formed thereon.
Δ: Streaks of films are formed thereon.
X: A film is formed on the entire surface thereof. (bad)

### 7. Particle Diameter

The weight average particle diameter and the number average particle diameter of a toner is by an instrument such as COULTER COUNTER TA-II or COULTER MULTISIZER II manufactured by Beckman Coulter Inc.

The procedure is as follows:
(1) a surfactant serving as a dispersant, preferably 0.1 to 5 ml of a 1% aqueous solution of an alkylbenzenesulfonic acid salt, is added to 100-150 ml of an electrolyte such as 1% aqueous solution of first class NaCl (in this case ISOTON-II manufactured by Beckman Coulter Inc. is used);
(2) 2 to 20 mg of a sample to be measured is added into the mixture;
(3) the mixture is subjected to an ultrasonic dispersion treatment for about 1 to 3 minutes; and
(4) the volume particle diameter distribution and number particle diameter distribution of the sample are determined using the above-mentioned instrument and an aperture of 100 μm to determine the weight average particle diameter and the number average particle diameter.

In the present invention, the following 13 channels are used:
(1) not less than 2.00 μm and less than 2.52 μm;
(2) not less than 2.52 μm and less than 3.17 μm;
(3) not less than 3.17 μm and less than 4.00 μm;
(4) not less than 4.00 μm and less than 5.04 μm;
(5) not less than 5.04 μm and less than 6.35 μm;
(6) not less than 6.35 μm and less than 8.00 μm;
(7) not less than 8.00 μm and less than 10.08 μm;
(8) not less than 10.08 μm and less than 12.70 μm;
(9) not less than 12.70 μm and less than 16.00 μm;
(10) not less than 16.00 μm and less than 20.20 μm;
(11) not less than 20.20 μm and less than 25.40 μm;
(12) not less than 25.40 μm and less than 32.00 μm; and
(13) not less than 32.00 μm and less than 40.30 μm.

Namely, particles having a particle diameter of from 2.00 μm to 40.30 μm are targeted.

### 8. Molecular Weight

The molecular weight distribution of a resin was measured by gel permeation chromatography (GPC). The measurement conditions are as follows.
(1) instrument: GPC-150C from Waters Corp.
(2) column: KF801-807 from Showa Denko KK
(3) concentration of sample: 0.05 to 0.6% by weight
(4) quantity of sample to be injected: 0.1 ml
(5) measurement temperature: 40° C.
(6) flow rate: 1.0 ml/min
(7) solvent: tetrahydrofuran

The number average molecular weight and weight average molecular weight of the resin were determined on the basis of the molecular weight distribution of the resin and a molecular weight calibration curve previously prepared using mono disperse polystyrene standard samples.

### 9. Glass Transition Temperature (Tg)

The glass transition temperature of a resin can be measured with a TG-DSC System TAS-100 from Rigaku Corporation. The method is as follows.
(1) about 10 mg of a sample which is contained in an aluminum container is set on a holder unit, and the holder unit is set in an electric furnace;
(2) the sample is heated from room temperature to 150° C. at a temperature rising speed of 10° C./min, followed by heating at 150° C. for 10 minutes and cooling to room temperature; and
(3) after the sample is allowed to settle at room temperature for 10 minutes, the sample is heated again from room temperature to 150° C. at a temperature rising speed of 10° C./min to obtain a DSC curve.

The glass transition temperature (Tg) of the sample is determined using an analyzing system of TAS-100. The glass transition temperature is defined as the temperature at which the tangent line of the endothermic curve crosses the base line.

### 10. Average Circularity

In the present application, the circularity of a toner is determined as follows using a flow-type particle image analyzer FPIA-2100 from Sysmex Corp.:
(1) at first water is provided, which is filtered to remove foreign particles therein such that 20 or less foreign particles having a circle-equivalent particle diameter of from 0.60 μm to 159.21 μm are included in a volume of 10⁻³ cm³;
(2) a few drops of a nonionic surfactant, CONTAMINON N from Wako Pure Chemical Industries, Ltd. are added to 10 ml of the above-prepared water;
(3) five (5) mg of a sample is added thereto, and the mixture is subjected to a dispersion treatment for 1 minute using a supersonic dispersing machine UH-50 from STM Co. Under conditions of 20 kHz in frequency and 50 W/10 cm³ in power, followed by a further dispersion for 4 minutes to prepare a dispersion in which particles of the sample are included in the dispersion at a concentration of from 4,000 to 8,000 pieces per 10 cm³; and
(4) the dispersion is analyzed by the instrument mentioned above to determine the circularity and the particle diameter distribution of the sample (particles having a circle-equivalent particle diameter of from 0.60 μm to 159.21 μm are targeted).

The procedure of measurements of the circularity and the particle diameter using FPIA-2100 is as follows.

A sample dispersion is flown through a transparent flat cell having a thickness of about 200 μm. A flash lamp emits light at intervals of 1/30 seconds to irradiate the flowing sample dispersion and a CCD camera 1, which is located on the opposite side of the flash lamp relative to the transparent flat cell, photographs the particles in the cell. The circle-equivalent particle diameters of the particles in the photographs are determined. By using this instrument, about 1200 particles can be analyzed per 1 minute. The particle diameters are classified into 226 channels in the range of from 0.06 μm to 159.21 μm.

The evaluation results are shown in Tables 1 and 2.

TABLE 1
(Two component developer is used.)

| | Image | Cleana- | Transfer- | Toner | Charge | Filming |
|---|---|---|---|---|---|---|
| | density | bility | ability | Scattering | stability | resistance |
| Ex. 1 | ◯ | ⊚ | ◯ | ⊚ | ◯ | ⊚ |
| Ex. 2 | ◯ | ◯ | ◯ | ◯ | ◯ | ⊚ |
| Ex. 3 | ◯ | ⊚ | ◯ | ⊚ | ◯ | ⊚ |
| Ex. 4 | ◯ | ◯ | ◯ | ◯ | ◯ | ⊚ |
| Ex. 5 | ◯ | ◯ | ◯ | ◯ | ◯ | ⊚ |
| Ex. 6 | ◯ | ◯ | ◯ | ◯ | ◯ | ⊚ |
| Ex. 7 | ◯ | ⊚ | ⊚ | ⊚ | ◯ | ⊚ |
| Ex. 8 | ◯ | ⊚ | ⊚ | ⊚ | ◯ | ⊚ |
| Ex. 9 | ◯ | ⊚ | ⊚ | ⊚ | ◯ | ⊚ |
| Ex. 10 | ◯ | ◯ | ◯ | ◯ | ◯ | ⊚ |
| Ex. 11 | ◯ | ⊚ | ⊚ | ⊚ | ◯ | ⊚ |
| Ex. 12 | ◯ | ⊚ | ⊚ | ⊚ | ◯ | ⊚ |
| Ex. 13 | ◯ | ⊚ | ⊚ | ⊚ | ◯ | ⊚ |
| Ex. 14 | ◯ | ◯ | ◯ | ◯ | ◯ | ⊚ |
| Ex. 15 | ◯ | ◯ | ◯ | ◯ | ◯ | ⊚ |
| Comp. | X | X | Δ | X | Δ | X |
| Ex. 1 | | | | | | |
| Comp. | Δ | X | X | X | X | X |
| Ex. 2 | | | | | | |
| Comp. | Δ | Δ | Δ | X | X | Δ |
| Ex. 3 | | | | | | |
| Comp. | Δ | X | X | X | X | Δ |
| Ex. 4 | | | | | | |

TABLE 2
(One component developer is used.)

| | Image | Cleana- | Transfer- | Toner | Charge | Filming |
|---|---|---|---|---|---|---|
| | density | bility | ability | Scattering | stability | resistance |
| Ex. 1 | ◯ | ◯ | ◯ | ◯ | ◯ | ⊚ |
| Ex. 2 | ◯ | ◯ | ◯ | Δ | ◯ | ⊚ |
| Ex. 3 | ◯ | ◯ | ◯ | ◯ | ◯ | ⊚ |
| Ex. 4 | ◯ | ◯ | ◯ | ◯ | ◯ | ⊚ |
| Ex. 5 | ◯ | Δ | ◯ | ◯ | ◯ | ⊚ |
| Ex. 6 | ◯ | Δ | ◯ | ◯ | ◯ | ⊚ |
| Ex. 7 | ◯ | ⊚ | ⊚ | ⊚ | ◯ | ⊚ |
| Ex. 8 | ◯ | ⊚ | ⊚ | ⊚ | ◯ | ⊚ |
| Ex. 9 | ◯ | ⊚ | ⊚ | ⊚ | ◯ | ⊚ |
| Ex. 10 | Δ | ◯ | ◯ | ◯ | Δ | ⊚ |
| Ex. 11 | ◯ | ⊚ | ⊚ | ⊚ | ◯ | ⊚ |
| Ex. 12 | ◯ | ⊚ | ⊚ | ⊚ | ◯ | ⊚ |
| Ex. 13 | ◯ | ⊚ | ⊚ | ⊚ | ◯ | ⊚ |
| Ex. 14 | Δ | ◯ | ◯ | ◯ | ◯ | ⊚ |
| Ex. 15 | Δ | ◯ | ◯ | ◯ | ◯ | ⊚ |
| Comp. | X | X | X | X | X | X |
| Ex. 1 | | | | | | |
| Comp. | X | X | X | X | X | X |
| Ex. 2 | | | | | | |
| Comp. | X | X | X | X | X | X |
| Ex. 3 | | | | | | |
| Comp. | X | X | X | X | X | X |
| Ex. 4 | | | | | | |

This document claims priority and contains subject matter related to Japanese Patent Application No. 2006-050426, filed on Feb. 27, 2006, incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A method for preparing a toner, comprising:
providing toner particles including at least a binder resin; and
contacting a coating fluid including a silicone resin and at least one of a super critical fluid and a sub-critical fluid with a surface of the toner particles to form thereon a layer including the silicone resin.

2. The method according to claim 1, wherein the binder resin is insoluble in the coating fluid.

3. The method according to claim 1, wherein the contacting step comprises:
spraying a coating fluid including a silicone resin and at least one of a super critical fluid and a sub-critical fluid to the toner particles to form thereon a layer including the silicone resin layer.

4. The method according to claim 1, wherein the contacting step comprises:
mixing the toner particles and a coating fluid including a silicone resin and at least one of a super critical fluid and a sub-critical fluid; and
then subjecting the mixture to pressure release to expand the coating fluid and to form a layer including the silicone resin on the toner particles.

5. The method according to claim 1, wherein the contacting step comprises:
mixing the toner particles and a coating fluid including a silicone resin and at least one of a super critical fluid and a sub-critical fluid; and
then changing at least one of pressure and temperature of the mixture to form a silicone resin layer on the toner particles.

6. The method according to claim 1, wherein the at least one of a super critical fluid and a sub-critical fluid includes carbon dioxide.

7. The method according to claim 1, wherein the at least one of a super critical fluid and a sub-critical fluid includes an entrainer.

8. The method according to claim 7, wherein the entrainer is included in an amount of from 0.1% by weight to 10% by weight based on a total weight of the entrainer and the at least one of a super critical fluid and a sub-critical fluid.

9. The method according to claim 7, wherein the silicone resin is insoluble in the entrainer under normal temperature and normal pressure conditions.

10. The method according to claim 7, wherein the entrainer is a member selected from the group consisting of methanol, ethanol and propanol.

11. The method according to claim 1, wherein the silicone resin includes a structure having the following formula: 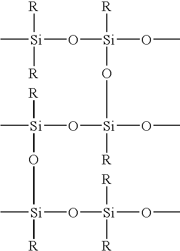
wherein, R represents a hydrogen atom, a hydroxyl group, an alkoxyl group, an alkyl group or an aryl group.

12. The method according to claim 1, wherein the silicone resin is a solid under normal temperature and normal pressure conditions.

13. The method according to claim 1, wherein the silicone resin includes silanol groups in an amount of from 0.1% by weight to 10% by weight.

14. The method according to claim 1, wherein the silicone resin has a weight average molecular weight of from 500 to 10,000.

15. A toner comprising:
toner particles including a binder resin; and
a layer located on a surface of the toner particles, wherein the layer includes a silicone resin,
wherein the toner is prepared by the method according to claim 1.

16. The toner according to claim 15, wherein the toner has a weight average particle diameter of from 3 to 8 μm.

17. A developer comprising:
the toner according to claim 15; and
a carrier.

18. An image forming method comprising:
developing an electrostatic image on an image bearing member with a developer including the toner according to claim 15 to form a toner image on the image bearing member;
transferring the toner image onto a receiving material; and
fixing the toner image on the receiving material upon application of heat and pressure thereto.

19. The image forming method according to claim 18, wherein the developing step is performed while applying an alternate electric field to the toner.

20. An image forming apparatus comprising:
an image bearing member configured to bear an electrostatic image thereon;
a developing device configured to develop the electrostatic image with a developer including the toner according to claim 15 to form a toner image on the image bearing member;
a transferring device configured to transfer the toner image onto a receiving material; and
a fixing device configured to fix the toner image on the receiving material upon application of heat and pressure thereto.

21. The image forming apparatus according to claim 20, wherein the image bearing member is a photoreceptor including amorphous silicon.

22. The image forming apparatus according to claim 20, wherein the fixing device includes:
a heating member;
a film contacted with the heating member to be heated; and
a pressure member configured to press the film to the heating member,
wherein the receiving material passes between the pressure member and the film.

23. A process cartridge comprising
an image bearing member configured to bear an electrostatic image thereon; and
a developing device configured to develop the electrostatic image with a developer including the toner according to claim 15 to form a toner image on the image bearing member,
wherein the image bearing member and the developing device are integrated, and the process cartridge is attachable to and detachable from an image forming apparatus.
